(19) United States
(12) Patent Application Publication
(10) Pub. No.: US 2010/0166606 A1
(43) Pub. Date: Jul. 1, 2010

(54) TRANSPORTING APPARATUS AND SAMPLE ANALYZER

(75) Inventors: Hiroki KOIKE, Kobe-shi (JP); Akio TOYODA, Kobe-shi (JP)

Correspondence Address: SUGHRUE MION, PLLC, 2100 PENNSYLVANIA AVENUE, N.W., SUITE 800, WASHINGTON, DC, 20037, US

(73) Assignee: Sysmex Corporation, Kobe-shi (JP)

(21) Appl. No.: 12/647,243

(22) Filed: Dec. 24, 2009

(30) Foreign Application Priority Data
Dec. 27, 2008 (JP) 2008-335507

(51) Int. Cl. G01N 35/04

(52) U.S. Cl. 422/65; 73/863.92

(57) ABSTRACT

A transporting apparatus for transporting a sample rack capable of holding a plurality of sample containers comprising: a transporting path that has a width allowing placing of each of a first sample rack and a second sample rack having a length in longitudinal direction greater than that of the first sample rack, the transporting path extending in a transporting direction intersecting the longitudinal direction of the first sample rack or the second sample rack placed on the transporting path; and a transport mechanism configured for transporting each of the first sample rack and the second sample rack placed on the transporting path in the transporting direction, is disclosed. A sample analyzer is also disclosed.

### FIELD OF THE INVENTION

The present invention relates to a transporting apparatus for transporting a sample rack that holds sample containers each containing a sample, such as blood, and a sample analyzer using the same.

### BACKGROUND

Regarding a sample analyzer that analyzes components in a sample, such as a blood analyzer or a blood coagulation analyzer, a sample container containing the sample is supplied by using a sample rack. The sample rack is set in a transporting apparatus of a sample analyzer with a plurality of sample containers held in a line therein. And the sample rack is transported by the transporting apparatus in such a manner that the sample containers are each sequentially located at a predetermined sample aspirating position. The sample analyzer is configured to aspirate the sample from each sample container located at the sample aspirating position, to measure components in the sample, and to perform predetermined analyses based on the measurement results.

As a transporting apparatus to be used in such a sample analyzer, for example, Japanese Laid-Open Patent Publication No. 2003-83993 and Japanese Laid-Open Patent Publication No. 2006-308560 disclose conventional transporting apparatuses each including a transport mechanism that transports sample racks in the rear direction. The sample racks are set with the longitudinal direction thereof (the direction in which sample containers are arranged in a line) set in the left-right direction.

There are various types of sample racks that are used in sample analyzers. Exemplary types of sample racks are, for example, a 10-sample rack (Sysmex Corporation) that is capable of holding ten sample containers and a 5-sample rack (Hitachi Ltd.) that is capable of holding five sample containers. Each of these sample racks is different not only in the number of sample containers that can be held therein, but also, for example, in the length of the sample rack in the direction in which the sample containers are arranged in a line and in the holding interval of the sample containers (pitch). As a result, each transporting apparatus has a different space in a transporting path and a different transporting pitch, depending on the type of the sample rack to be used. Thus, each transporting apparatus can only use one type of sample rack.

Accordingly, for example, when a sample analyzer for 10-sample racks is replaced with a new sample analyzer for 5-sample racks in an institution such as a hospital, the 10-sample racks owned by the institution can no longer be used in the new sample analyzer. Therefore, there is a problem that 10-sample racks become useless. Also, in a large-scale testing center or a large hospital, there is a case in which a plurality of types of sample analyzers each using a different type of sample rack are concurrently used. However, both types of these sample racks cannot be commonly used with these sample analyzers, which causes inconvenience.

Moreover, for manufacturers of sample analyzers, in order to allow for a plurality of types of sample racks, it is necessary to design and manufacture a different transporting apparatus for each type of sample rack, which causes a problem of high development costs and high manufacturing costs.

### SUMMARY OF THE INVENTION

The scope of the present invention is defined solely by the appended claims, and is not affected to any degree by the statements within this summary.

A first aspect of the present invention is a transporting apparatus for transporting a sample rack capable of holding a plurality of sample containers comprising: a transporting path that has a width allowing placing of each of a first sample rack and a second sample rack having a length in longitudinal direction greater than that of the first sample rack, the transporting path extending in a transporting direction intersecting the longitudinal direction of the first sample rack or the second sample rack placed on the transporting path; and a transport mechanism configured for transporting each of the first sample rack and the second sample rack placed on the transporting path in the transporting direction.

A second aspect of the present invention is a sample analyzer, comprising: a transporting apparatus for transporting a sample rack capable of holding a plurality of sample containers; a dispenser for dispensing a sample from each of the plurality of sample containers held by the sample rack transported by the transporting apparatus; a measurement unit for performing measurement on the sample dispensed by the dispenser; and an analysis unit for analyzing a measurement result obtained by the measurement unit, wherein the transporting apparatus comprises: a transporting path that has a width allowing placing of each of a first sample rack and a second sample rack having a length in longitudinal direction greater than that of the first sample rack, the transporting path extending in a transporting direction intersecting the longitudinal direction of the first sample rack or the second sample rack that has been placed on the transporting path; and a transport mechanism configured for transporting each of the first sample rack and the second sample rack placed on the transporting path in the transporting direction.

### BRIEF DESCRIPTION OF THE DRAWINGS

FIG. 1 is a general view of a sample analyzer according to an embodiment of the present invention;

FIG. 2 is a plan view schematically showing an overall configuration of a measurement apparatus in the sample analyzer shown in FIG. 1;

FIG. 3 is a block diagram of the measurement apparatus shown in FIG. 2;

FIG. 4 is a block diagram of a control unit shown in FIG. 3;

FIG. 5 is a perspective view of a sample rack holding sample containers.

FIG. 6 is a front view of the sample rack.

FIG. 7 is a perspective view showing another example of the sample rack.

FIG. 8 is a perspective view showing another example of the sample container.

FIG. 9A is a schematic plan view showing a rack set region in a state where 10-sample racks are set;

FIG. 9B is a schematic plan view showing the rack set region in a state where 10-sample racks are set;

FIG. 10A is a schematic plan view showing the rack set region in a state where 5-sample racks are set;

FIG. 10B is a schematic plan view showing the rack set region in a state where 5-sample racks are set;

FIG. 11 is a front view illustrating a rack feed-in mechanism;

FIG. 12 is a side view illustrating the rack feed-in mechanism;

FIG. 13 is an enlarged front sectional view showing a guide member;

FIG. 14 is a side view illustrating the manner of attaching the guide member;

FIG. 15 is a plan view schematically showing a rack cross-feed mechanism;

FIG. 16 is a side view schematically illustrating an essential part of an engagement unit;

FIG. 17 is a front view of the engagement unit in a state before the engagement unit is engaged with a sample rack.

FIG. 18 is a front view of the engagement unit in a state after the engagement unit is engaged with the sample rack.

FIG. 19 is a front view of the engagement unit in a state after the engagement unit is engaged with a sample rack of another example.

FIG. 20 is a perspective view showing a base body of the engagement unit.

FIG. 21 is a perspective view showing an action member of the engagement unit.

FIG. 22A is a front view illustrating a pair of engagement members;

FIG. 22B is a front view illustrating the pair of the engagement members;

FIG. 23A is an enlarged side sectional view showing a transporting path in a transport region;

FIG. 23B is an enlarged side sectional view showing the transporting path in the transport region;

FIG. 24 is a block diagram of an information processing apparatus;

FIG. 25A is a schematic plan view showing the process of transporting sample racks performed by a transporting unit;

FIG. 25B is a schematic plan view showing the process of transporting the sample racks performed by the transporting unit;

FIG. 26A is a schematic plan view showing the process of transporting the sample racks performed by the transporting unit;

FIG. 26B is a schematic plan view showing the process of transporting the sample racks performed by the transporting unit;

FIG. 27A is a schematic plan view showing the process of transporting the sample racks performed by the transporting unit;

FIG. 27B is a schematic plan view showing the process of transporting the sample racks performed by the transporting unit;

FIG. 28 is a flowchart showing steps of operations in the transporting process performed by the transporting unit;

FIG. 29 is a flowchart showing steps of operations in the transporting process performed by the transporting unit;

FIG. 30 is a flowchart showing steps of operations in the transporting process performed by the transporting unit;

FIG. 31 is a flowchart showing steps of operations in a transporting process performed by a transporting unit according to a second embodiment of the present invention;

FIG. 32A is a schematic plan view showing a feed-in member A301, which is another example of a feed-in member (transporting member) A3;

FIG. 32B is a schematic plan view showing the feed-in member A301, which is another example of the feed-in member (transporting member) A3;

FIG. 33A is a schematic plan view showing a feed-in member A305, which is another example of the feed-in member (transporting member) A3; and

FIG. 33B is a schematic plan view showing the feed-in member A305, which is another example of the feed-in member (transporting member) A3.

### DETAILED DESCRIPTION OF THE PREFERRED EMBODIMENTS

Hereinafter, embodiments of a transporting apparatus of the present invention and a sample analyzer using the same will be described with reference to the accompanying drawings. Note that the present invention is not limited to these embodiments.

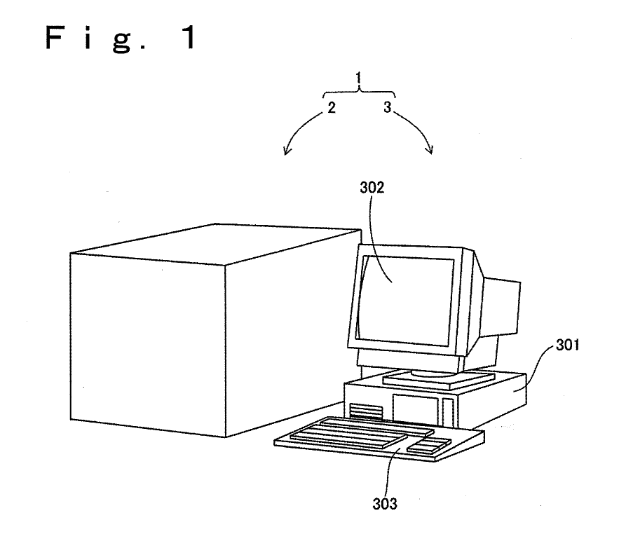

FIG. 1 is a general view of a sample analyzer according to a first embodiment of the present invention. A sample analyzer 1 according to the present embodiment is a blood coagulation measuring apparatus for optically measuring and analyzing a sample by using a coagulation time method, a synthetic substrate method, immunonephelometry, and a platelet aggregation method. The sample analyzer 1 includes: a measurement apparatus 2 that optically measures components contained in a sample (blood); and an information processing apparatus 3 that analyzes measurement data obtained from the measurement apparatus 2.

[Configuration of the Measurement Apparatus]

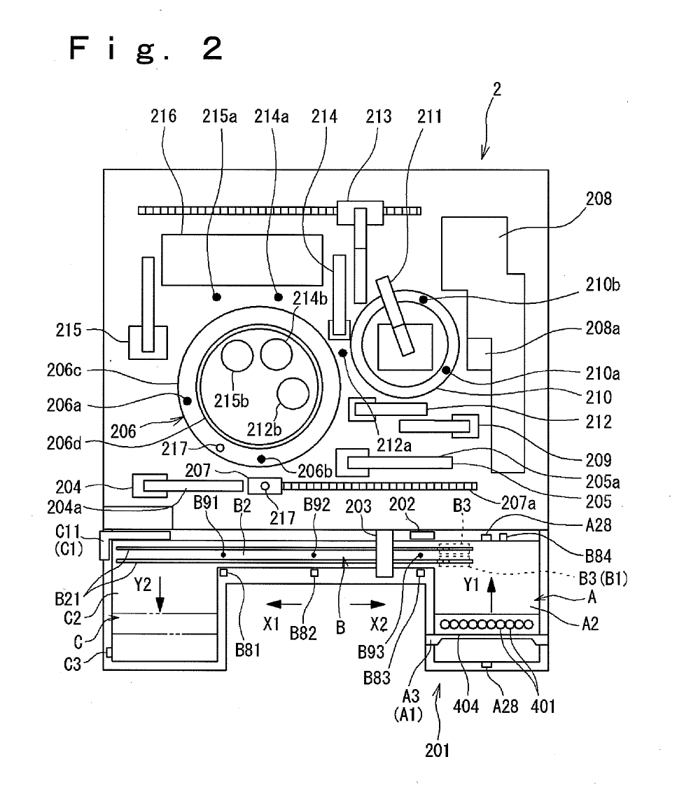

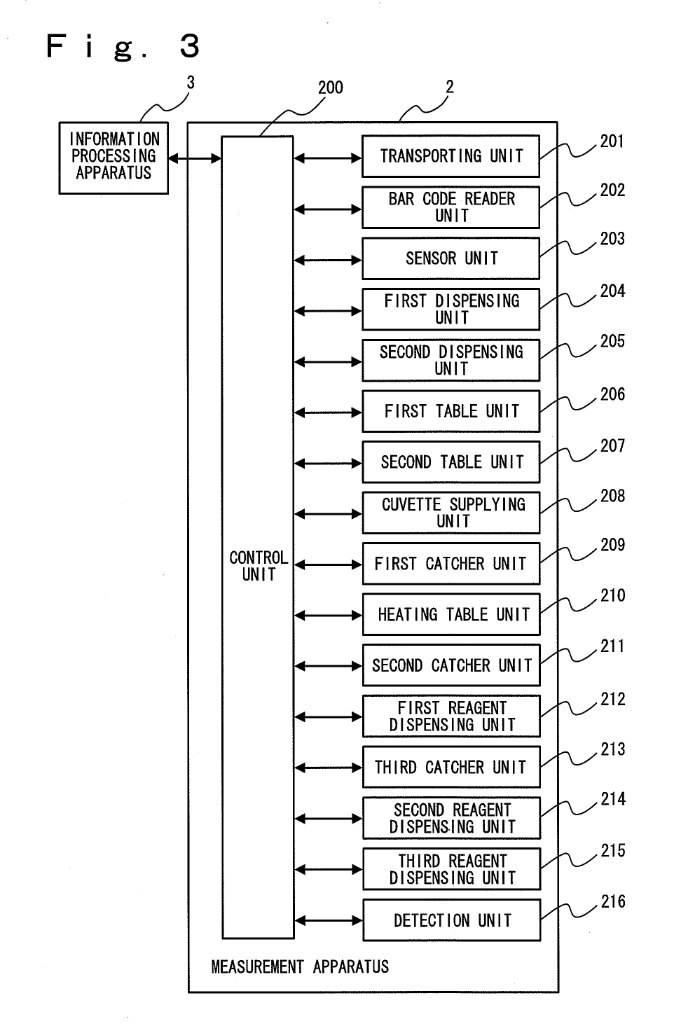

FIG. 2 is a plan view schematically showing an overall configuration of the measurement apparatus 2 shown in FIG. 1. The measurement apparatus 2 includes: a transporting unit (transporting apparatus) 201, a bar code reader unit (reader) 202, a sensor unit 203, a first dispensing unit (dispenser) 204, a second dispensing unit (dispenser) 205, a first table unit 206 including a reagent table 206d and a cuvette table 206c, a second table unit 207, a cuvette supplying unit 208, a first catcher unit 209, a heating table unit 210, a second catcher unit 211, a first reagent dispensing unit 212, a third catcher unit 213, a second reagent dispensing unit 214, a third reagent dispensing unit 215, a detection unit 216, and a control unit 200 (see FIG. 3).

FIG. 3 is a block diagram of the measurement apparatus 2 shown in FIG. 2. As shown in FIG. 3, the control unit 200 is interconnected with the transporting unit 201, the bar code reader unit 202, the sensor unit 203, the first dispensing unit 204, the second dispensing unit 205, the first table unit 206, the second table unit 207, the cuvette supplying unit 208, the first catcher unit 209, the heating table unit 210, the second catcher unit 211, the first reagent dispensing unit 212, the third catcher unit 213, the second reagent dispensing unit 214, the third reagent dispensing unit 215, and the detection unit 216. The control unit 200 is configured to be able to control the operation of each unit. The control unit 200 is connected to the information processing apparatus 3 so that the control unit 200 and the information processing apparatus 3 can communicate with each other.

[Configuration of the Control Unit]

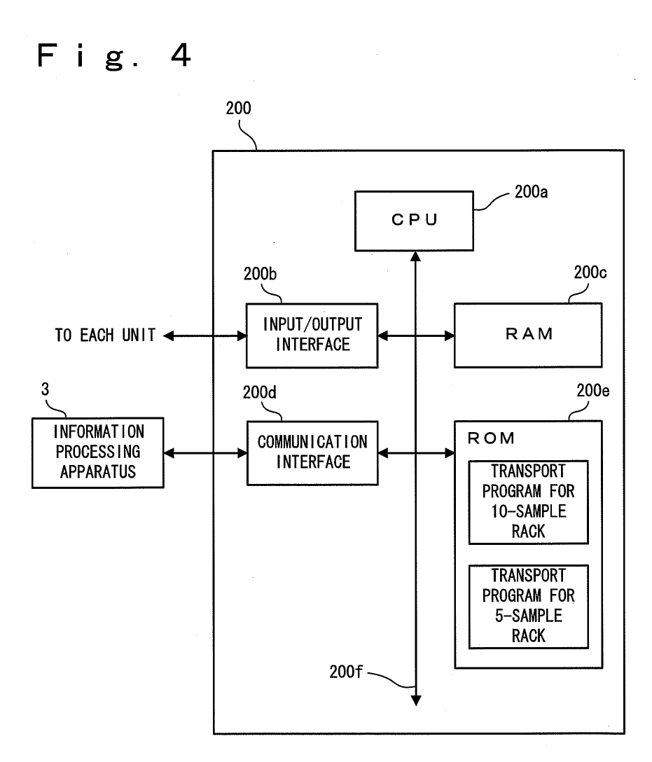

FIG. 4 is a block diagram of the control unit 200 shown in FIG. 3. As shown in FIG. 4, the control unit 200 includes: a CPU 200a, an input/output interface 200b, a RAM 200c, a communication interface 200d, and a ROM 200e. The CPU 200a, the input/output interface 200b, the RAM 200c, the communication interface 200d, and the ROM 200e are connected to each other via a bus 200f.

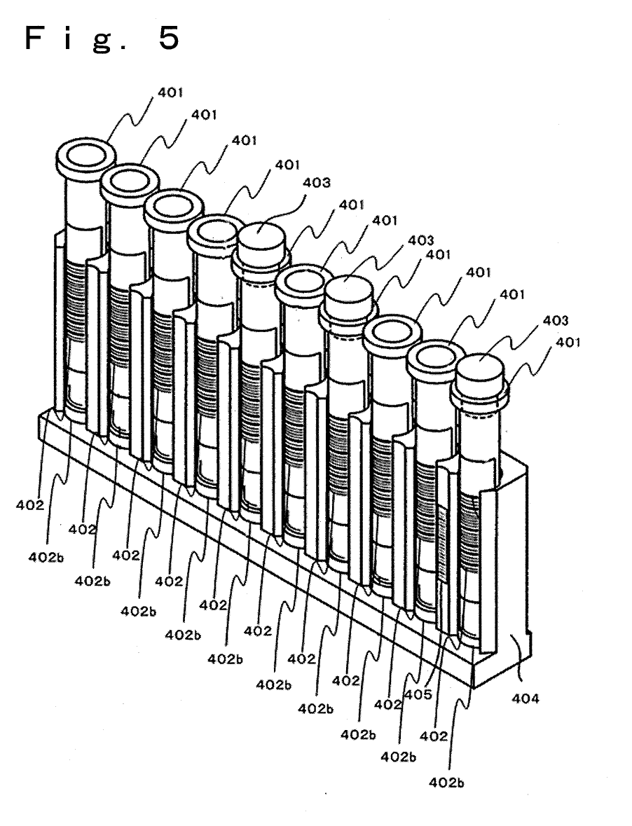

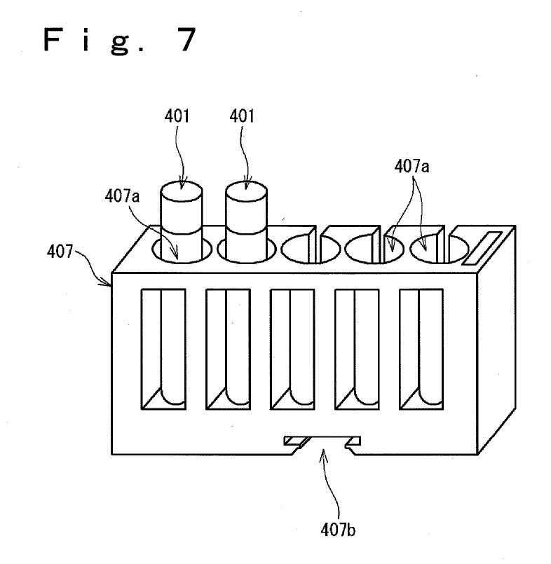

The CPU 200a is provided so as to execute a computer program stored in the ROM 200e and a computer program loaded to the RAM 200c. The ROM 200e is structured as a mask ROM, a PROM, an EPROM, an EEPROM or the like. The ROM 200e stores computer programs to be executed by the CPU 200a, data to be used by these computer programs, and the like. As described below, the configuration of the present embodiment allows a plurality of types of sample racks 404 and 407 (see FIG. 5 and FIG. 7) to be used, and the ROM 200e stores a transport program for the sample rack 404 and a transport program for the sample rack 407.

The RAM 200c is structured as an SRAM, a DRAM or the like. The RAM 200c is used for reading computer programs stored in the ROM 200e. The RAM 200c is also used as a work area for the CPU 200a when the CPU 200a executes these computer programs.

The input/output interface 200b outputs a command provided from the CPU 200a to each unit of the measurement apparatus 2. The input/output interface 200b receives information transmitted from each unit, and transmits the received information to the CPU 200a.

The communication interface 200d is an Ethernet (registered trademark) interface. By using a predetermined communication protocol (TCP/IP) and via the communication interface 200d, the measurement apparatus 2 is capable of transmitting/receiving data to/from the information processing apparatus 3 that is connected to the measurement apparatus 2 by a LAN cable.

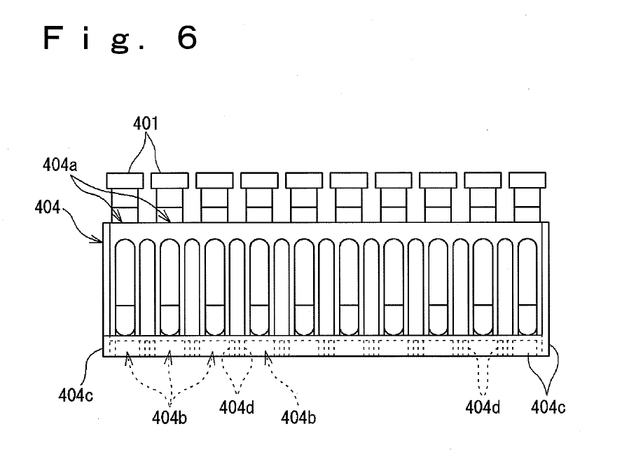

Here, description is given on sample containers each containing a sample to be analyzed by the sample analyzer 1, and on a sample rack holding the sample containers. FIG. 5 is a perspective view of the sample rack holding sample containers and FIG. 6 is a front view thereof.

The sample container 401 contains a sample (blood) that is collected at a hospital or the like. Further, a bar code 402 containing identification information is attached to each sample container 401 for identification thereof. The sample containers 401 may each be provided with a cap 403 attached thereto.

The sample rack 404 is provided with ten holders 404a arranged in a line. These ten holders 404a each accommodate one sample container 401. In the case where the size of a sample container 401 is smaller than that of a holder 404a, an adaptor (not shown) is used so as to prevent the sample container 401 from tilting or falling.

The sample rack 404 is provided with openings 402b so as to allow the bar codes 402 of the sample containers 401 to be read by the bar code reader unit 202 (see FIG. 2). Further, a bar code 405 containing identification information for identifying the sample rack 404 is attached to the sample rack 404.

As shown in FIG. 6, on the bottom face of the sample rack 404, a plurality of recesses 404b (ten recesses so as to correspond to the ten holders 404a) that are downwardly open are formed along the longitudinal direction of the sample rack 404. Each recess 404b is defined by wall portions 404c that constitute lower peripheral walls of the sample rack 404 and by wall portions 404d provided between adjacent recesses 404b.

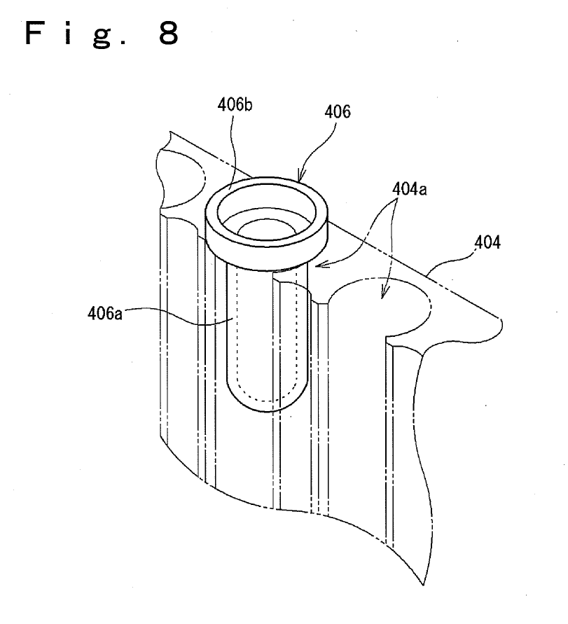

FIG. 8 is a perspective view showing another example of the sample container. In the present embodiment, a sample container 406 shown in FIG. 8 can also be used. The sample container 406 is shorter in the up-down direction and of smaller volume than the sample container 401 shown in FIG. 5 and FIG. 6. The sample container 406 is held by the sample rack 404 when a lower part 406a of the sample container 406 is inserted into a holder 404a of the sample rack 404 and an upper part 406b of the sample container 406 is concurrently engaged with (placed on) the upper edge of the holder 404a.

The sample container 406 is used, for example, in the case where only a small amount of sample can be taken from a patient, or where a measurement is performed only once. Specifically, the sample container 406 can be used in the case where small-amount measurement described below is performed.

FIG. 7 is a perspective view showing another example of the sample rack. In a sample rack 407, five holders 407a for holding sample containers 401, respectively, are formed, and the five holders 407a are arranged in a line. Each of the holders 407a accommodates one sample container 401. Also, on the bottom of the sample rack 407, there is formed only one recess 407b that is open in the downward, front, and rear directions. Note that, although not shown, a bar code 405 is also attached to the sample rack 407, in the same manner as the sample rack 404.

The sample rack 407 is different from the sample rack 404 shown in FIG. 5, not only in the number of the sample containers 401 that can be held, but also in the length in which the sample containers 401 are arranged in a line and in the pitch for holding the sample containers 401. The transporting unit 201 of the present embodiment is configured to be able to transport both types of racks, i.e., the sample rack 404 and the sample rack 407, and is configured to transport a selected one of the two types of the sample racks. Further, the measurement apparatus 2 of the present embodiment is configured to be able to aspirate both a sample contained in the sample container 401 accommodated in the sample rack 404 and a sample contained in the sample container 401 accommodated in the sample rack 407, each of which is transported by the transporting unit 201. Note that, in the description below, the sample rack 404 capable of holding ten sample containers 401 may be referred to as a 10-sample rack, and the sample rack 407 capable of holding five sample containers 401 may be referred to as a 5-sample rack.

[Configuration of the Transporting Unit]

As shown in FIG. 2, the transporting unit 201 is provided with a rack set region A, a transport region B, and a rack storing region C, in each of which regions sample racks 404 holding sample containers 401 can be placed. In each region A to C, each sample rack 404 is placed with the longitudinal direction thereof set in the left-right direction. The transporting unit 201 is configured to transport each sample rack 404 set in the rack set region A in a direction indicated by an arrow Y1 (to the rear); transport each sample rack 404 having entered the transport region B in directions indicated by arrows X1 and X2 (left-right direction); and transport each sample rack 404 further having entered the rack storing region C in a direction indicated by an arrow Y2 (to the front). Note that FIG. 2 shows an example using 10-sample racks 404, but 5-sample racks 407 are also placed and transported in the regions A to C in a similar manner to that of the 10-sample racks 404.

[Configuration of the Rack Set Region]

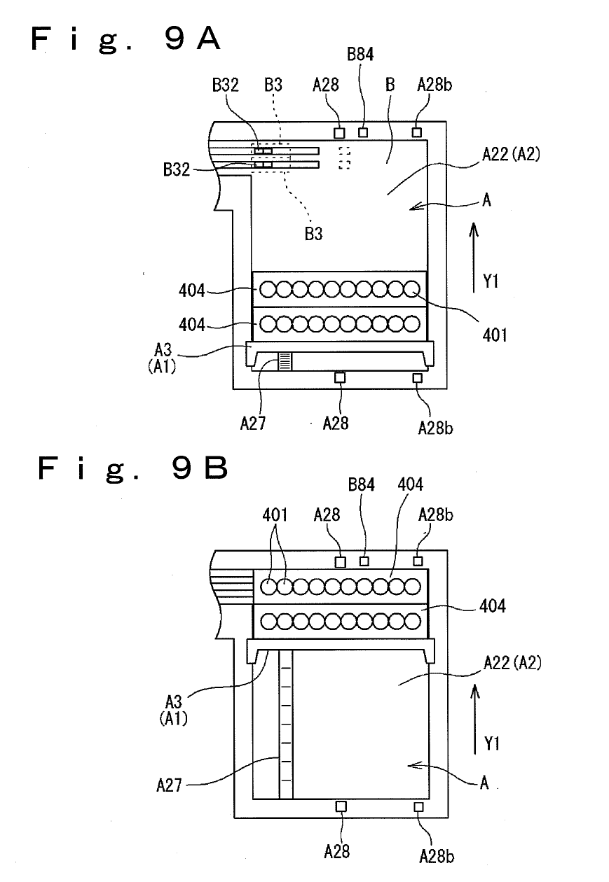

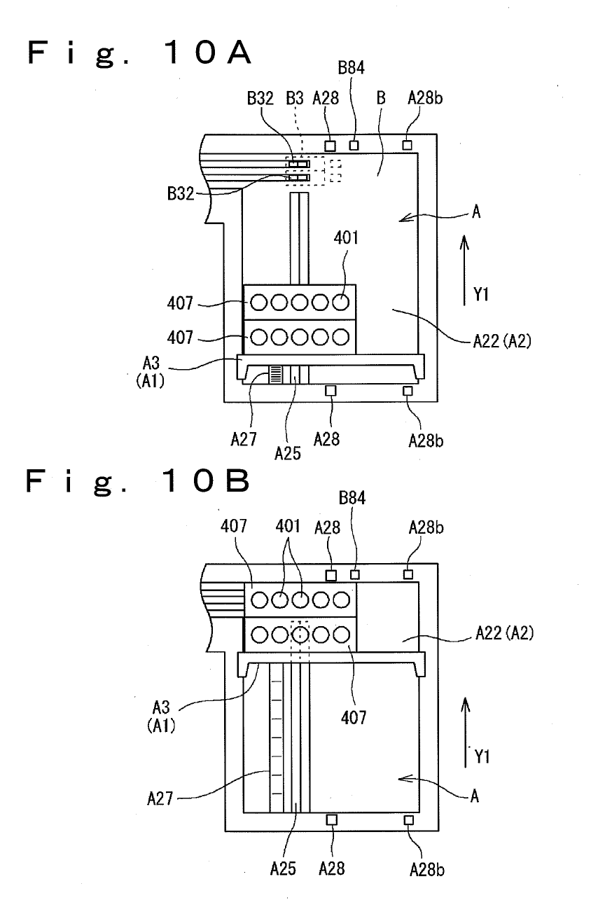

Each of FIG. 9A and FIG. 9B, and FIG. 10A and FIG. 10B is a schematic planview showing the rack set region. Specifically, FIG. 9A and FIG. 9B each show a state where 10-sample racks 404 are set, and FIG. 10A and FIG. 10B each show a state where 5-sample racks 407 are set. The rack set region A is configured such that a plurality of sample racks 404 or 407 can be placed thereon, arranged in parallel in the front-rear direction, with the longitudinal direction of the sample racks 404 or 407 set in the left-right direction. Also, the rack set region A is provided with a rack feed-in mechanism (a first rack transport mechanism; a transport mechanism of the present invention) A1 for transporting the placed sample racks 404 or 407 in the direction indicated by the arrow Y1.

Hereinafter, the rack feed-in mechanism A1 is described in detail.

The rack set region A is provided with a placing platform (placing section) A2 on which a plurality of sample racks are placing. On the top face of the placing platform A2, a transporting path A22 for transporting sample racks 404 or 407 is formed. The transporting path A22 has a width, in the left-right direction, that allows a sample rack 404 or 407 as shown in FIG. 5 and FIG. 7 to be placed with the longitudinal direction thereof set in the left-right direction, and has a length, in the front-rear direction, that allows a plurality of sample racks 404 or 407 to be placed in parallel with each other in the front-rear direction. Further, the transporting path A22 extends in a direction (transporting direction) perpendicular to the longitudinal direction of the placed sample racks 404 or the placed sample racks 407.

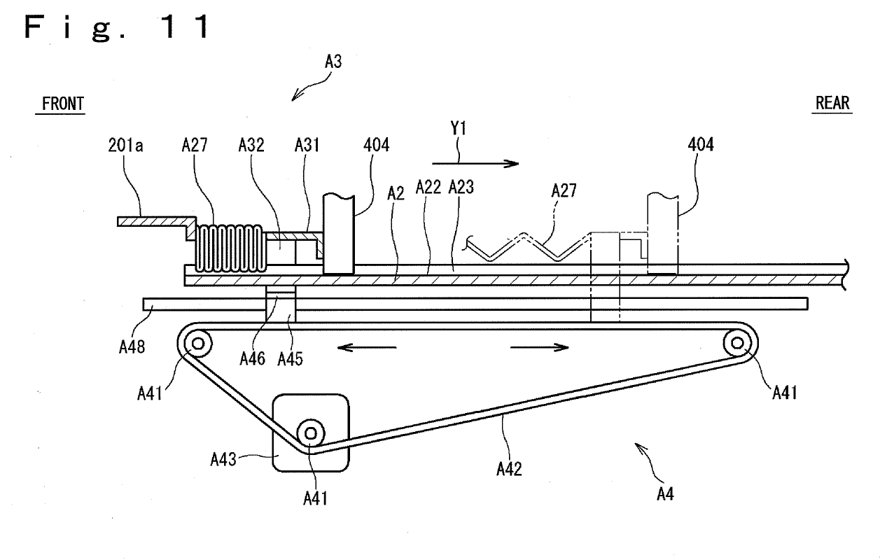

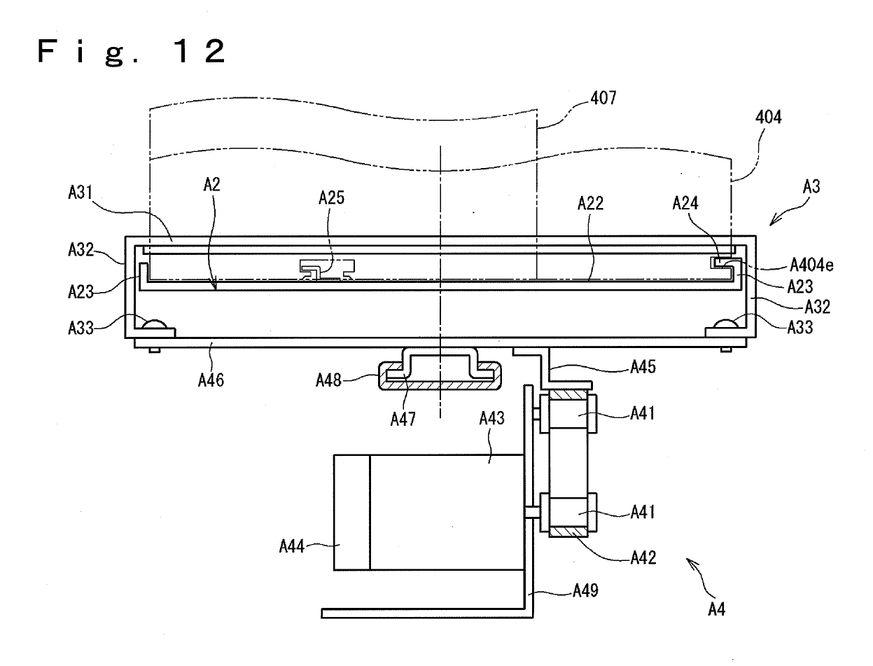

The rack feed-in mechanism A1 includes: a feed-in member (transporting member) A3 engageable with a sample rack 404 or 407 arranged in the rack set region A, and a movement mechanism A4 (see FIG. 11 and FIG. 12) for moving the feed-in member A3 in the Y1 direction or the reverse direction thereof (Y2 direction). The feed-in member A3 is arranged in such a manner as to engage (contact) the front face of the sample rack 404 or 407, among the sample racks 404 or 407 arranged in the rack set region A, that is on the most upstream side in the Y1 direction. The rack feed-in mechanism A1 is configured to move the feed-in member A3 in the Y1 direction by means of the movement mechanism A4, so as to transport all the sample racks 404 or 407 placed on the transporting path A22 in the direction indicated by the arrow Y1, thereby sequentially feeding the sample racks 404 or 407 into the transport region B.

As shown in FIG. 11 and FIG. 12, the movement mechanism A4 includes: a feed-in belt A42 wound around a plurality of pulleys A41 that are spaced from each other in the front-rear direction; an electric motor A43 connected to one of the pulleys A41; and an encoder (position sensor) A44 that detects the number of rotations of the electric motor A43. The pulleys A41 and the electric motor A43 are fixed onto a frame of the transporting unit 201 via a bracket A49 or the like. A strip-shaped support member A46, which is long in the left-right direction, is connected to the feed-in belt A42 via a connection member A45.

On the other hand, the feed-in member A3 includes: a contact portion A31 that extends, in the left-right direction, over the length, in the left-right direction, of a 10-sample rack 404; and attachment portions A32 that extends downwardly from both ends of the contact portion A31, respectively. Bottom end portions of the attachment portions A32 are fixed onto both ends of the support member A46 by fixtures A33 such as screws, respectively. In this manner, the top, bottom, left, and right sides of the placing platform A2 are externally surrounded by the support member A46 and the feed-in member A3.

On the bottom face of the support member A46, a guide shoe A47 is attached. The guide shoe A47 is fitted in a guide rail A48, such that the guide shoe A47 can slide in the front-rear direction. The guide rail A48 is provided, in the front-rear direction, below the placing platform A2, on the frame of the transporting unit 201 in such a manner as to be hung therefrom.

On each end portion (left and right) of the placing platform A2, formed is a bent portion A23 that is bent approximately 90° upward from the placing platform A2. The bent portions A23 slidably contact the left and right end portions of a 10-sample rack 404 placed on the transporting path A22, respectively, so as to position the sample rack 404 with respect to the left and the right directions. In this manner, the bent portions A23 constitute guide members that guide the transportation of the sample rack 404 in the front-rear direction. Further, one of the left bent portion A23 and the right bent portion A23 (right side in FIG. 12) has an upper end portion A24 extending inwardly (to the left) in the left-right direction. The upper end portion A24 is slidably fitted in a groove 404e formed in the lower part on one of the side faces of the sample rack 404. The upper end portion A24 functions as a fall-prevention member that prevents the 10-sample rack 404 from falling on the transporting path A22.

As shown in FIG. 10A and FIG. 10B, 5-sample racks 407 shown in FIG. 7 can also be placed on the transporting path A22. Each 5-sample rack 407 has a shorter length, than the 10-sample rack 404, in the direction in which the sample containers 401 are arranged in a line (left-right direction). Each 5-sample rack 407 is placed, on the transporting path A22, in such a manner as to be located to the left-most side or the right-most side (left-most side in the present embodiment).

As shown in FIG. 12, the 5-sample rack 407 is positioned, with respect to the left direction, by the left guide member A23 of the placing platform A2. However, the 5-sample rack 407 is spaced from the right guide member A23, and thus, the 5-sample rack 407 cannot be positioned by the right guide member A23. Therefore, in the present embodiment, when 5-sample racks 407 are to be placed on the transporting path A22, a dedicated guide member A25 is attached.

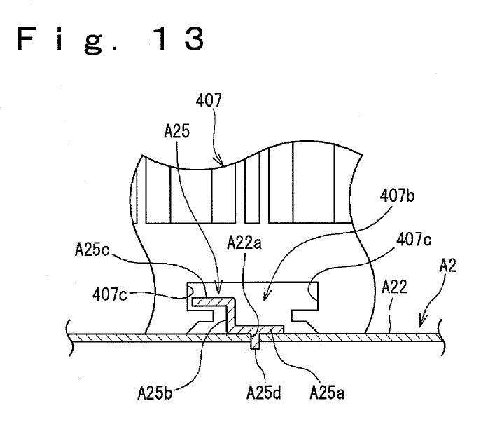

FIG. 13 is an enlarged front sectional view showing the guide member A25. The guide member A25 is formed to have a substantially Z-shaped cross-section. The guide member A25 includes: a base portion A25a contacting the top face of the transporting path A22; an erect wall portion A25b extending upwardly from one end (left end) of the base portion A25a; and a restricting portion A25c extending to one side in the left-right direction (to the left side) from the upper end of the erect wall portion A25b. The guide member A25 is inserted into the recess 407b formed in the bottom face of a 5-sample rack 407 placed on the transporting path A22. Subsequently, the restricting portion A25c is inserted into one of groove portions 407c formed on the left and right sides in the recess 407b. By using the guide member A25, it is possible to position the 5-sample rack 407 with respect to the right direction, and to prevent the 5-sample rack 407 from falling.

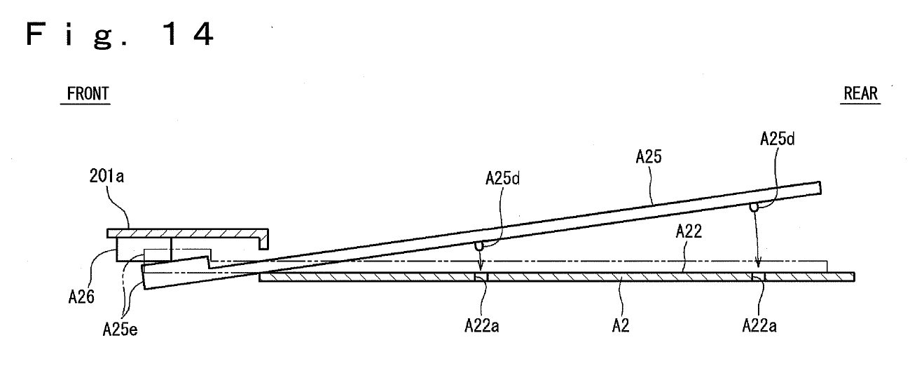

As shown in FIG. 10A and FIG. 10B, the guide member A25 is arranged on the transporting path A22 of the placing platform A2 in the front-rear direction, and is detachably attached to the placing platform A2. To be specific, as shown in FIG. 13, on the bottom face of the base portion A25a of the guide member A25, a plurality of fitting protrusions A25d, which protrude downwardly, respectively, are formed in a plurality of positions. In the placing platform A2, there formed are fitting holes (attachment portions) A22a in which the fitting protrusions A25d detachably fit, respectively. As shown in FIG. 14, the front end portion of the guide member A25 is obliquely inserted into the gap between the front end portion of the placing platform A2 and a front end frame 201a of the transporting unit 201, and the fitting protrusions A25d are inserted into the fitting holes A22a, respectively. In this manner, the guide member A25 is attached to the placing platform A2.

As shown in FIG. 14, at the front end of the guide member A25, a detection plate A25e is integrally formed with the guide member A25. The front end frame 201a is provided with a detection sensor A26, which includes a transmission type photo sensor or the like, for detecting the detection plate A25e. In the state where the guide member A25 is obliquely inserted in the gap between the placing platform A2 and the front end frame 201a, the detection sensor A26 receives emitted light, which is a transmission state, and does not detect the detection plate A25e. When the fitting protrusions A25d are inserted into the fitting holes A22a with the guide member A25 held horizontally, emitted light to be received by the detection sensor A26 is blocked by the detection plate A25e, thereby allowing the detection sensor A26 to detect that the guide member A25 has been attached to the placing platform A2.

As shown in FIG. 9A to FIG. 11, between the feed-in member A3 and the front end frame 201a of the transporting unit 201, there provided is a place blocking member A27 for preventing sample racks 404 or 407 from being placed therebetween. The place blocking member A27 is a bellow-shaped member having one end connected to the feed-in member A3 and the other end connected to the front end frame 201a. The place blocking member A27 is configured to be able to expand and contract. The place blocking member A27 expands or contracts in accordance with the movement of the feed-in member A3. Accordingly, it is possible to prevent a user from inadvertently placing sample racks 404 or 407 in the space on the transporting path A22, the space being on the upstream side, of the feed-in member A3 in the transporting direction Y1.

The rack set region A is provided with a detection sensor A28 for detecting the presence/absence of sample racks 404 or 407 in the rack set region A. The detection sensor A28 includes transmission type photo sensors or the like provided at the upstream end and the downstream end of the Y1 direction, respectively, in the rack set region A. The detection sensor A28 is configured such that emitted light is blocked when a sample rack 404 or 407 exists in the rack set region A, and emitted light is received (i.e., transmission state) when a sample rack 404 does not exist in the rack set region A.

[Configuration of the Transport Region]

The transport region B has placing space that has a width in the front-rear direction, the width allows one sample rack 404 or 407 to be moved in the left-right direction; and a width in the left-right direction, the width is three or more times greater than the length of one sample rack 404. The transport region B is provided with a rack cross-feed mechanism B1 (a second rack transport mechanism; a second transport mechanism of the present invention) for transporting a sample rack 404 in an X1 direction and an X2 direction between the rack set region A and the rack storing region C.

Hereinafter, the configuration of the rack cross-feed mechanism B1 is described in detail with reference to FIG. 2 and FIG. 15 to FIG. 22B.

As shown in FIG. 2, the transport region B of the transporting unit 201 is provided with a placing platform B2 for supporting, from below, sample racks 404 or 407. A transporting path B22 for the sample racks 404 or 407 is formed on the top face of the placing platform B2. The rack cross-feed mechanism B1 is arranged below the placing platform B2.

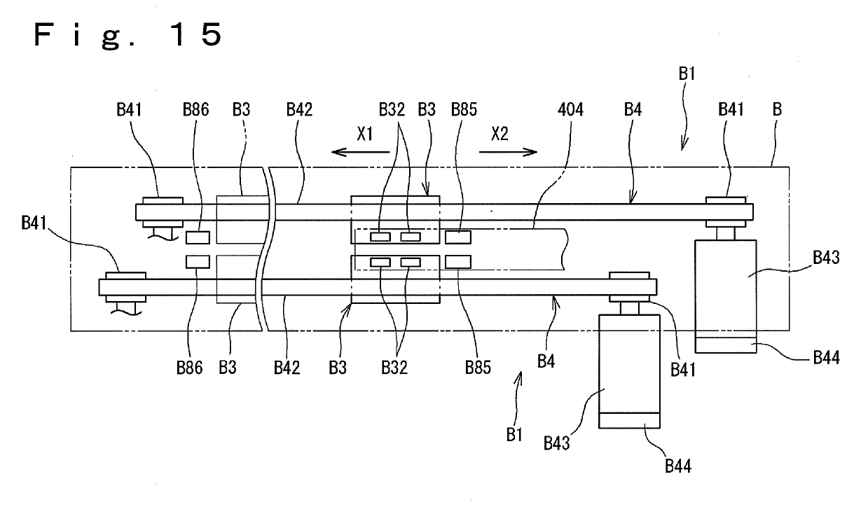

FIG. 15 is a plan view schematically showing the rack cross-feed mechanism B1. In the present embodiment, two rack cross-feed mechanisms B1 are provided in parallel in the front-rear direction. Each rack cross-feed mechanism B1 includes: an engagement unit B3 engageable with a sample rack 404 or 407; and a movement mechanism B4 for moving the engagement unit B3 in the X1 direction and the X2 direction.

The movement mechanism B4 includes: a pair of pulleys B41 arranged at both ends of the transport region B; a transporting belt B42 wound around the pulleys B41; an electric motor B43 for rotating one of the pulleys B41; and an encoder (position sensor) B44 for detecting the number of rotations of the electric motor 843. The transporting belts B42 of the movement mechanisms B4 of the two rack cross-feed mechanisms B1 are arranged along the X1-X2 direction, in parallel to each other in the front-rear direction.

The engagement unit 83 is connected to the transporting belt B42 of the movement mechanism 34. The engagement unit B3 is configured to be moved in the X1 direction and the X2 direction through operation of the electric motor B43. The amount of movement of the engagement unit B3 is detected by the encoder B44 as the number of rotations of the electric motor B43. The operation of the electric motor B43 is controlled by the control unit 200 based on the detection results by the encoder B44. A movement start point of the engagement unit B3 (standby position) and a movement end point thereof are set on the upstream side and the downstream side of the X1 direction, respectively. Detection sensors B85 and B86, which each includes a transmission type photo sensor or the like, for detecting the engagement unit B3 arranged at the movement start point and the movement end point, respectively, are arranged relative to the engagement unit B3.

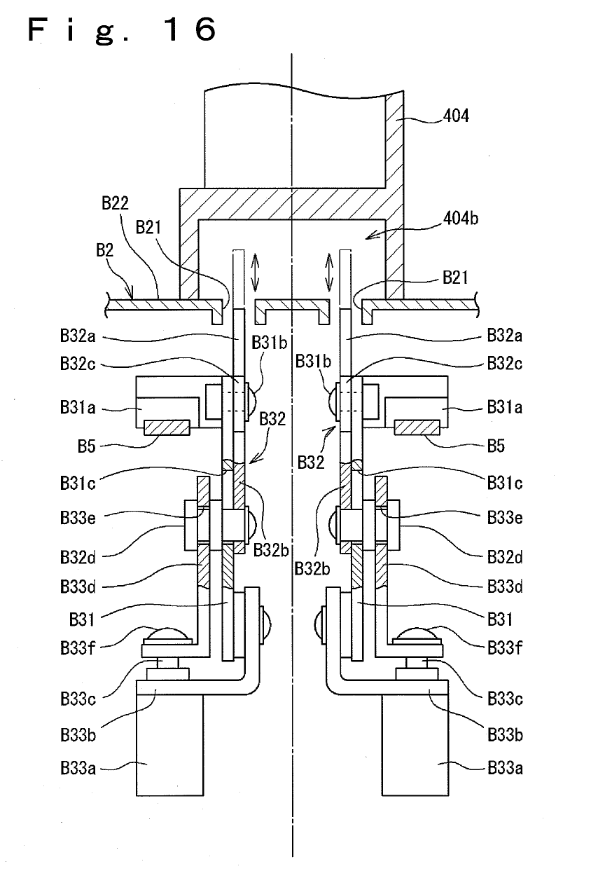

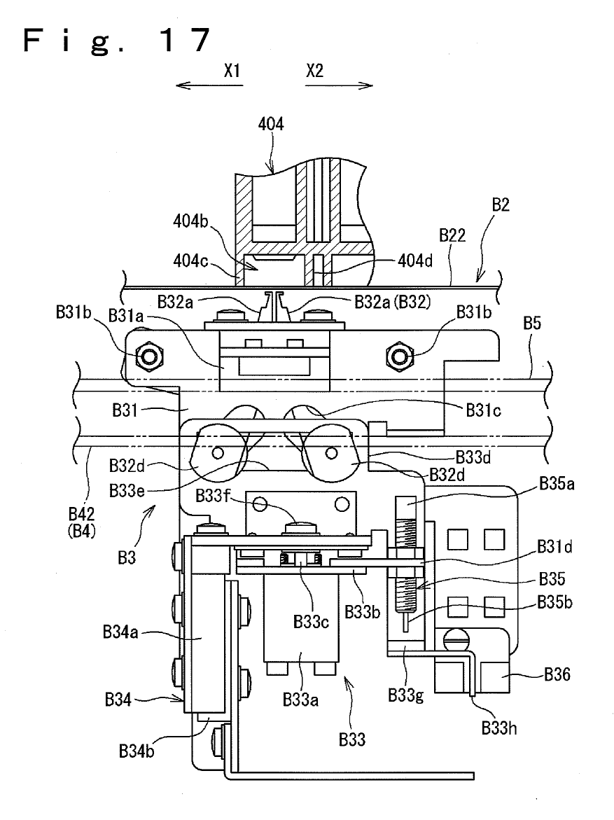

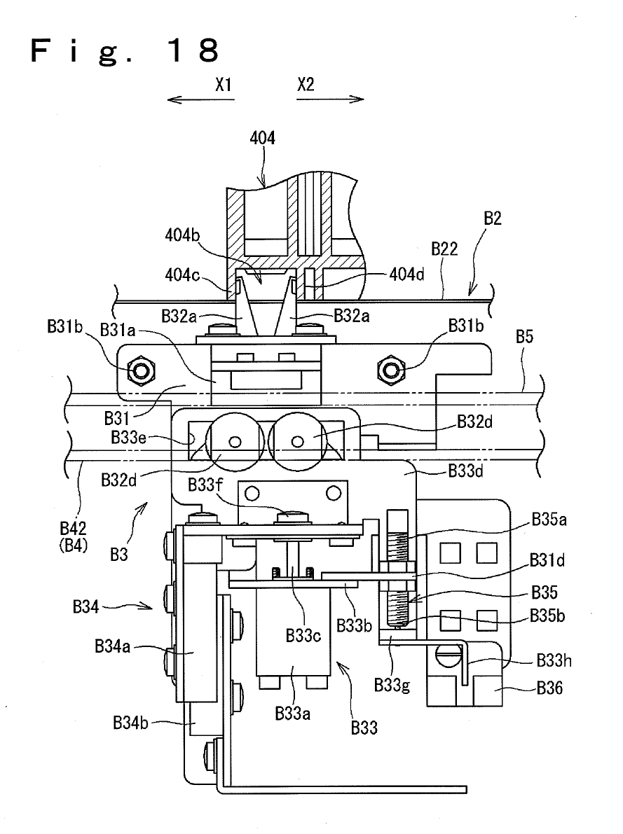

FIG. 16 is a side view schematically illustrating an essential part of an engagement unit. FIG. 17 is a front view of the engagement unit in a state before the engagement unit is engaged with a sample rack. FIG. 18 is a front view of the engagement unit in a state where the engagement unit is engaged with the sample rack.

The engagement unit B3 includes a base body B31, a pair of engagement members B32, a drive section B33, an ascending/descending guide B34, a resistance applying member B35, and an ascent/descent detection sensor B36.

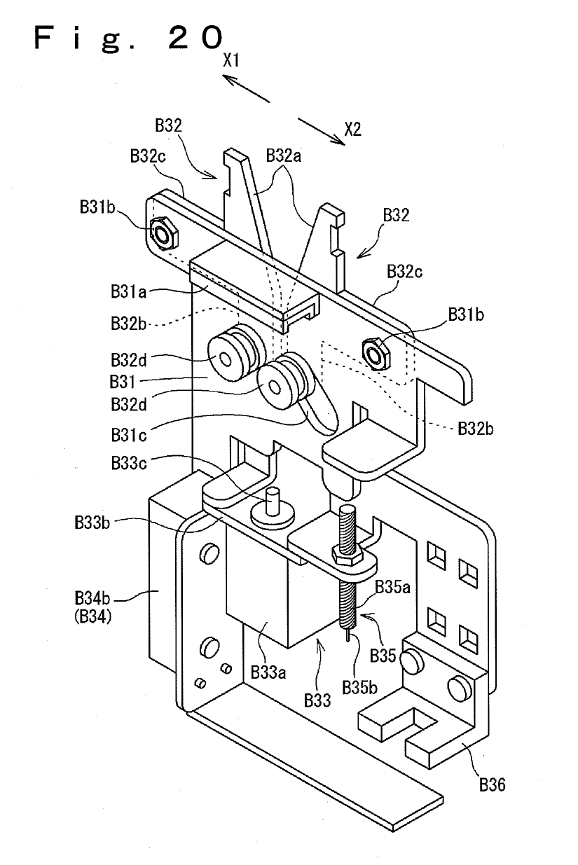

FIG. 20 is a perspective view showing the base body B31 of the engagement unit B3, and the components attached thereto.

As shown in FIG. 17 and FIG. 20, the base body B31 is formed from a plate material, such as stainless steel. The upper part of the base body B31 is arranged such that the plate surface thereof is arranged, along the transporting directions X1 and X2. To the upper part of the base body B31, a guide shoe B31a is attached. The guide shoe B31a is slidably fitted with a guide rail B5 that is arranged, below the transporting path B22, along the X1-X2 direction. The guide rail B5 supports the base body B31 such that the base body B31 can move in the X1 and X2 directions.

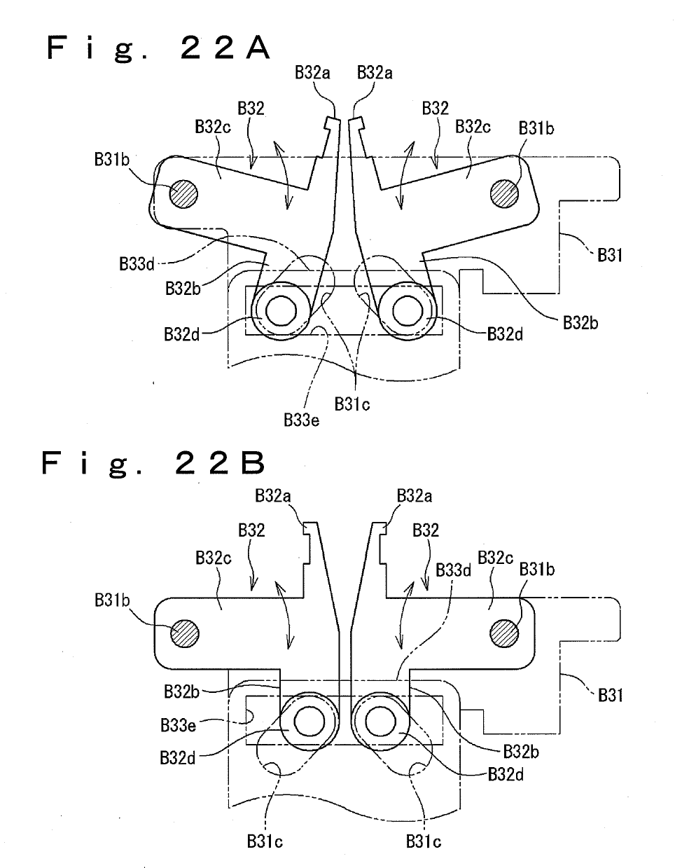

Further, in the upper part of the base body B31, a pair of engagement members B32 are attached so as to be rotatable about an axis extending in the front-rear direction that is perpendicular to the X1-X2 direction. FIG. 22A and FIG. 22B are front views each illustrating the pair of the engagement members B32. The pair of the engagement members B32 are arranged in such a manner as to be opposed to each other in the X1-X2 direction (left-right direction). Each of the pair of the engagement members B32 is formed from a plate material, such as stainless steel, and the plate surface thereof is aligned along the X1-X2 direction.

As shown in FIG. 20, each of the pair of the engagement members B32 is provided with an engagement claw B32a in the upper part thereof, and with a support portion B32b in the lower part thereof. An arm portion B32c is provided between the engagement claw B32a and the support portion B32b, the arm portion B32c protruding outwardly in the left (or right) direction.

The end of the arm portion B32c is rotatably attached, by a fixture B31b composed of bolts and nuts, to the base body B31. An engagement roller B32d is provided at the lower end of the support portion B32b. The engagement roller B32d is movably fitted in a corresponding one of restriction holes 331c formed in the base body B31. Each restriction hole B31c is shaped to conform with an arc of the circumference of a circle about the fixture 331b (or an elongate hole of a similar shape). Each restriction hole B31c restricts, in a predetermined manner, the rotation range of a corresponding one of the pair of engagement members B32 (movement range of the engagement roller B32d).

As shown in FIG. 17 and FIG. 20, an air cylinder (drive source) B33a, which is the drive source of the drive section B33, is attached via a bracket B33b to the lower part of the base body B31. To the air cylinder B33a, compressed air is supplied from a compressor not shown. The air cylinder B33a includes a rod B33c that ascends or descends in the up-down direction in accordance with the supply of compressed air.

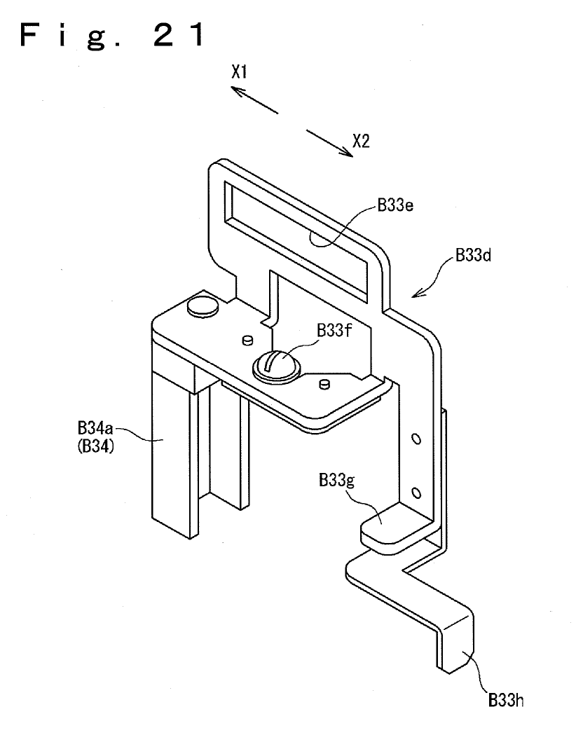

An action member B33d, which forms the drive section B33 together with the air cylinder B33a, is fixed to the upper end of the rod B33c of the air cylinder B33a. FIG. 21 is a perspective view showing the action member B33d. The action member B33d is formed from a plate material, such as a stainless plate. In the upper part of the action member B33d, a rectangle engagement hole B33e is formed. The rectangle engagement hole B33e is long in the left-right direction and is to be engaged by the engagement rollers B32d of the pair of the engagement members B32. The lower part of the action member B33d is connected, by a mounting screw B33f, to the rod B33c of the air cylinder B33a.

When the rod B33c of the air cylinder B33a ascends or descends, the action member B33d also ascends or descends, and the pair of the engagement members B32 rotate in the up-down direction via the engagement rollers B32d being engaged in the engagement hole B33e. The engagement claws B32a of the pair of the engagement members B32 perform, while ascending, a separating action so as to separate from each other (see FIG. 22B); and perform, while descending, an approaching action so as to approach each other (see FIG. 22A).

As shown in FIG. 17, in the state where the pair of the engagement members B32 have been rotated downwardly, the engagement claws B32a are located below the transporting path (placing platform) B2, and the engagement claws B32a are not engaged with the sample rack 404. As shown in FIG. 18, when the pair of the engagement members B32 are rotated upwardly, the pair of the engagement claws B32a protrude from the transporting path B22, and concurrently, advance into the recess 404b formed in the bottom of the sample rack 404, and separate from each other. In this manner, the engagement claws B32a contact both of the wall portions 404c and 404d provided on the X1 and X2 direction sides in the recess 404b, respectively. Accordingly, the pair of the engagement members B32 are engaged with the sample rack 404, and now the sample rack 404 is ready to be transported.

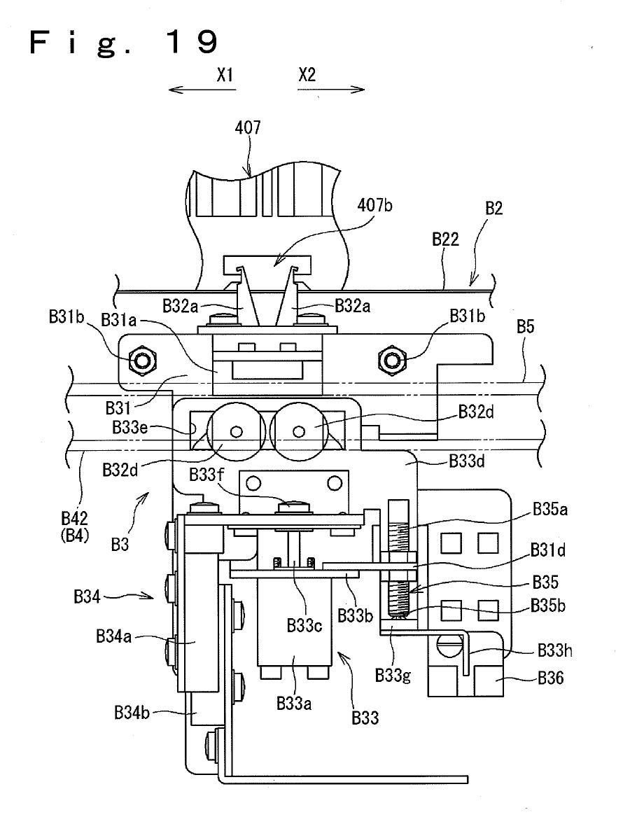

FIG. 19 shows a state where the pair of the engagement members B32 are engaged with the recess 407b of a 5-sample rack 407. In this case, the pair of the engagement claws B32a contact two end faces on the X1 and X2 direction sides in the recess 407b, respectively.

As shown in FIG. 2 and FIG. 16, in the transporting path B22, two slits B21 arranged in parallel in the front-rear direction are formed along the X1-X2 direction. The engagement claws B32a of the pair of the engagement members B32 are capable of protruding through the slits B21 into the space above the transporting path B22, respectively. The engagement claws B32a are capable of moving in the slits B21 in the X1 and X2 directions.

As shown in FIG. 17, the ascending/descending guide B34 of the engagement unit B3 includes: a guide rail B34a, which is provided on one side (left side), in the left-right direction, of the lower part of the action member B33d, extends in the up-down direction, and has a cross-section of a U-shape turned sideways; and a guide block B34b, which is provided on one side (left side), in the left-right direction, of the lower part of the base body B31 and is slidably fitted with the guide rail B34a. The ascending/descending guide B34 guides ascending/descending movement, relative to the base body B31, of the action member B33d.

As shown in FIG. 17 and FIG. 18, the resistance applying member B35 applies resistance to rotational actions of the pair of the engagement members B32. The resistance applying member B35 is caused by the drive section B33. The rotational actions of the pair of the engagement members B32 is engaging and disengaging actions with respect to the sample rack 404 or 407. The resistance applying member B35 is an oil type shock absorber fixed, by a nut, to an attachment piece B31d formed on the base body B31. The resistance applying member B35 includes: an outer cylinder 335a, which is arranged in the up-down direction; and a rod B35b protruding downwardly from the bottom of the outer cylinder. To the rod B35b, downward force is applied by the oil contained within the outer cylinder B35a, and the rod B35b is capable of contacting a contact piece B33g provided on the other side (right side), in the left-right direction, of the action member B33d.

When the action member B33d ascends through the operation of the air cylinder B33a, the rod B35b of the resistance applying member B35 also ascends. However, the applied downward force reduces the ascending speed of the action member B33d. Accordingly, the momentum is damped at the time when the pair of the engagement members B32 rotate in the directions in which the pair of the engagement members B32 are to be engaged with the sample rack 404 or 407. Accordingly, it is possible to prevent the pair of engagement members 332 from strongly colliding with the sample rack 404 or 407.

The ascent/descent detection sensor B36 includes a transmission type photo sensor or the like fixed on the other side (right side) of the base body B31 in the left-right direction. The ascent/descent detection sensor B36 is configured such that when the action member B33d descends through the operation of the air cylinder B33a, emitted light is blocked by a detection piece B33h formed on the action member B33d. Accordingly, when the ascent/descent detection sensor B36 is in the transmission state, it is possible to determine that the pair of the engagement members B32 have ascended and been engaged with the sample rack 404 or 407. When emitted light to be received by the ascent/descent detection sensor B36 is blocked by the detection piece B33h, it is possible to determine that the pair of the engagement members B32 has been disengaged from the sample rack 404 or 407.

As shown in FIG. 20, each of the pair of the engagement members B32 is arranged with the plate surface thereof arranged along the X1-X2 direction, and each of the pair of the engagement members B32 is thin in the front-rear direction. The air cylinder B33a, the ascending/descending guide B34, the ascent/descent detection sensor B36, and the resistance applying member B35, which are included in the engagement unit B3, are arranged along the X1-X2 direction. This arrangement allows the entire engagement unit B3 to be thin in the front-rear direction. As a result, as shown in FIG. 16, it is possible to arrange two engagement units B3 in parallel in accommodation space, which is narrow in the front-rear direction and is provided below the transporting path B22.

As shown in FIG. 2, a first sample aspirating position B91 and a second sample aspirating position B92 are set in the transport region B. The sample in a sample container 401, when located at the first sample aspirating position B91 or the second sample aspirating position B92 by means of the rack cross-feed mechanism B1, is aspirated by a first dispensing unit 204 or a second dispensing unit 205.

Also in the transport region B, a bar code reading position B93 is set for reading the bar code 402 attached to a sample container 401 and for reading the bar code 405 attached to a sample rack 404 or 407.

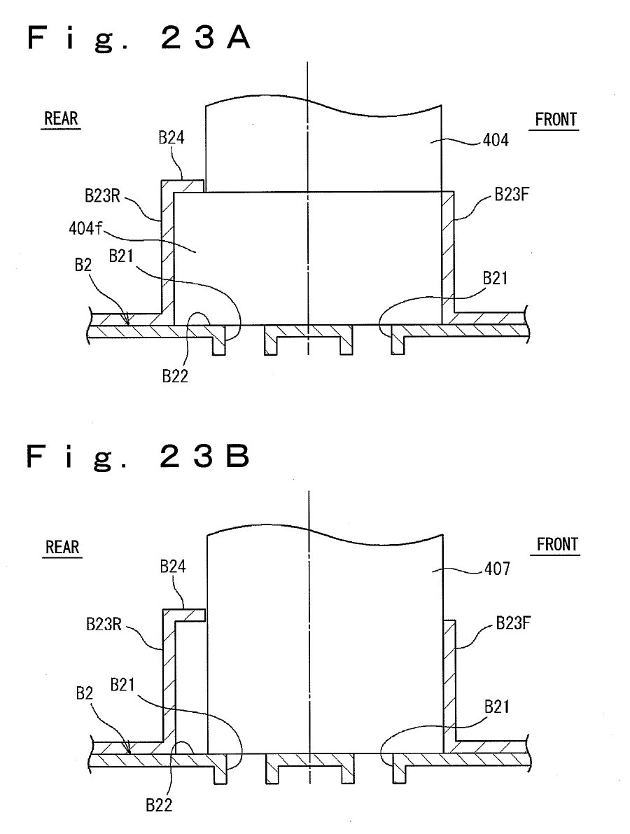

Each of FIG. 23A and FIG. 23B is an enlarged side sectional view showing the transporting path B22 in the transport region B. As shown in FIG. 23A, the lower part of the sample rack (10-sample rack) 404 is provided with a protruding portion 404f that protrudes from one side face (rear face in FIG. 23A), in the front-rear direction, of the sample rack 404. Thus, due to the existence of the protruding portion 404f, the lower part of the 10-sample rack 404 has a wider width in the front-rear direction than the upper part thereof.

On both front and rear sides of the transporting path B22, guide members B23F and B23R are provided for positioning the 10-sample rack 404 with respect to the front-rear direction and for guiding the transportation of the rack in the left-right direction. At the upper end of the rear guide member B23R, a bent portion B24 extending to the front is formed. The bent portion B24 is arranged so as to fit along the top face of the protruding portion 404f. The bent portion B24 is formed as a restricting portion that restricts upward movement of the 10-sample rack 404, so as to prevent the 10-sample rack 404 placed on the transporting path B22 from being removed upwardly.

As shown in FIG. 23B, the sample rack (5-sample rack) 407 does not include the protruding portion 404f as in the 10-sample rack 404, and is formed to have a substantially constant front-rear width in the up-down direction. They-sample rack 407 is positioned by the front guide member B23F with respect to the front direction. However, since the 5-sample rack 407 does not include the protruding portion, the 5-sample rack 407 is spaced from the rear guide member B23R, and thus cannot be positioned by the guide member B23R with respect to the rear direction. Therefore, in the present embodiment, the front edge of the restricting portion B24 provided in the upper end of the guide member B23R is arranged in such a manner as to fit along the rear face of the 5-sample rack 407. Accordingly, the 5-sample rack 407 is positioned by the restricting portion B24 with respect to the rear direction, and the transportation of the 5-sample rack 407 in the left-right direction is guided by the restricting portion B24 and the guide member B23F. Also, at this time, through the action of the engagement members B32 shown in FIG. 19, it is possible to prevent the 5-sample rack 407 from being removed upwardly.

[Configuration of the Rack Storing Region]

As shown in FIG. 2, the rack storing region C includes a placing platform (placing section) C2 that allows a plurality of sample racks 404 or 407 to be placed thereon in parallel in the front-rear direction. The rack storing region C is provided with a rack feed-out mechanism (a third rack transport mechanism) C1 for transporting the placed sample racks 404 or 407 in the direction indicated by the arrow Y2. The rack feed-out mechanism C1 includes: a feed-out member C11 that contacts the sample rack 404 or 407 located at a transport end (left end) of the transport region B; and a movement mechanism (not shown) that moves the feed-out member C11 in the Y2 direction and the reverse direction (Y1 direction). The rack feed-out mechanism C1 is configured to move, by causing the feed-out member C11 to move in the Y2 direction by means of the movement mechanism, the sample rack 404 or 407 in the Y2 direction by one pitch (the length, in the Y1-Y2 direction, of the sample rack 404 or 407), thereby feeding the sample rack 404 or 407 from the transport region B into the rack storing region C.

A transporting path is provided on the top face of the placing platform C2 in the rack storing region C. The transporting path is capable of having the 10-sample racks 404 placed thereon, and capable of having the 5-sample racks 407 placed thereon. The rack feed-out mechanism C1 is capable of transporting the sample racks 404 and capable of transporting the sample racks 407. Specifically, the feed-out member C11 is capable of contacting the face on the upstream side (rear face), in the transporting direction, of a sample rack 404 or 407. Therefore, the rack feed-out mechanism C1 in the rack storing region C is also a part of the transport mechanism of the present invention. Note that the 5-sample racks 407 are placed in such a manner as to be located to the left-most side of the transporting path, and are transported via the feed-out member C11. When the 5-sample racks 407 are transported, the guide member A25 as shown in FIG. 13 may be attached to the placing platform C2.

A detection sensor C3 for detecting presence/absence of a sample rack 404 or 407 is provided in the rack storing region C. The detection sensor C3 includes a transmission or reflection type photo sensor or the like, and is configured to detect the sample rack 404 or 407 that has been sent to the most downstream side (transport end) in the rack storing region C.

[Configuration of the Bar Code Reader Unit]

As shown in FIG. 2, the bar code reader unit 202 is configured to be able to read the bar code 402 or 405 located at the bar code reading position B93. The bar code reader unit 202 is capable of transmitting, to the control unit 200, identification information contained in the bar code 402 or 405.

Note that at the first sample aspirating position B91, the second sample aspirating position B92, and the bar code reading position 393, detection sensors B81, B82, and B83 are provided, respectively. The detection sensors B81, B82, and B83 each include a transmission or reflection type photo sensor or the like. The detection sensors B81, B82, and B83 are configured to detect a sample rack 404 or 407 and a sample container 401 that have been transported to the positions B91, B92, and 393, respectively. A detection sensor B84 including a transmission or reflection type photo sensor or the like is also provided for detecting a sample rack 404 or 407 located at the upstream end (right end) in the X1 direction in the transport region B.

[Configuration of the Sensor Unit]

As shown in FIG. 2, the sensor unit 203 is configured to be able to obtain information that allows the control unit 200 to make a determination of presence/absence of the cap 403 attached on a sample container 401. The sensor unit 203 is configured to detect presence/absence of the cap 403 by determining whether or not light emitted from above the sample container 401 by a light emitter is received by a light receiver arranged below the sample container 401.

[Configuration of the Dispensing Unit]

As shown in FIG. 2, the first dispensing unit 204 is configured to be able to aspirate the sample from a sample container 401 that has been transported to the first sample aspirating position B91 by the transporting unit 201, and to be able to discharge the sample into a cuvette 217 in a container position 206a on the cuvette table 206c. The first dispensing unit 204 rotates an arm 204a having a pipette to the first sample aspirating position B91, aspirates via the pipette the sample from the sample container 401 which is in the position B91, further rotates the arm 204a to the container position 206a, and discharges the aspirated sample into the cuvette 217 in the container position 206a. Note that in the case where the cap 403 is attached on the sample container 401, the first dispensing unit 204 is able to aspirate the sample by causing the pipette to penetrate the cap 403.

The second dispensing unit 205 is configured to be able to aspirate the sample from a sample container 401 transported to the second sample aspirating position B92 by the transporting unit 201, and to be able to discharge the sample into a cuvette 217 held by the second table unit 207. Also, the second dispensing unit 205 is able to aspirate, from the cuvette 217, a predetermined amount of the sample depending on a measurement item. The cuvette 217 is in a container position 206b and the first dispensing unit 204 has dispensed the sample into the cuvette 217. The second dispensing unit 205 is able to discharge the predetermined amount of the sample into a cuvette 217 on the second table unit 207.

The second dispensing unit 205 rotates the arm 205a having a pipette to the second sample aspirating position B92 or the container position 206b, aspirates via the pipette the sample from a sample container 401 or a cuvette 217 at the position B92 or 206b, respectively, further rotates the arm 205a, and discharges the sample into a cuvette 217 on the second table unit 207.

Note that, the sample analyzer 1 of the present embodiment is configured to be able to perform two types of measurements: standard measurement and small-amount measurement. The standard measurement is a measurement process that includes a process of dispensing, from a sample container 401, the sample, by an amount that allows a plurality of measurements (standard measurement, reflex test, etc.) to be performed for one measurement item. The small-amount measurement is a measurement process that includes a process of dispensing, from a sample container 401, the sample, by an amount that allows only one measurement to be performed for one measurement item.

The first dispensing unit 204 is used for aspirating the sample from a sample container 401 at the first sample aspirating position B91 on the transporting unit 201, when the standard measurement is performed.

The second dispensing unit 205 is used for aspirating the sample from a cuvette 217 at the container position 206b on the cuvette table 206c, when the standard measurement is performed. Further, the second dispensing unit 205 is used for aspirating the sample from a sample container 401 at the second sample aspirating position B92 on the transporting unit 201, when the small-amount measurement is performed.

[Configuration of the Table Unit]

As shown in FIG. 2, the reagent table 206d of the first table unit 206 is a round table configured to be able to hold: a first reagent container 212b that contains a first reagent; a second reagent container 214b that contains a second reagent; and a third reagent container 215b that contains a third reagent. The reagent table 206d is capable of rotating in both the clockwise direction and the counterclockwise direction.

The cuvette table 206c of the first table unit 206 is provided outside the reagent table 206d. The cuvette table 206c is an annular table, and is configured to be able to hold cuvettes 217 via a plurality of insertion holes (not shown) provided therein. The cuvette table 206c can move a cuvette 217 to the container position 206a or to the container position 206b, by rotating in the clockwise direction or in the counterclockwise direction.

The second table unit 207 is configured to be able to hold a cuvette 217 via an insertion hole (not shown) provided therein, and to be able to slidably move in the left-right direction on a slide rail 207a. The second table unit 207 stands by, while holding a vacant cuvette 217 at the left end of the slide rail 207a. The second table unit 207 is also capable of moving to the right end of the slide rail 207a, while holding the cuvette 217 into which the sample has been dispensed by the second dispensing unit 205.

[Configuration of the Cuvette Supplying Unit]

As shown in FIG. 2, the cuvette supplying unit 208 is configured to be able to sequentially supply, to a cuvette storing section 208a, a plurality of cuvettes 217 which have been fed into the cuvette supplying unit 208 at random by a user. The cuvettes 217 having been supplied to the cuvette storing section 208a are each transferred by the second catcher unit 211 to the cuvette table 206c or by the first catcher unit 209 to the second table unit 207.

[Configuration of the Catcher Unit and the Heating Table Unit]

As shown in FIG. 2, the first catcher unit 209 is configured to be able to transfer, to a container position 210a of the heating table unit 210, the cuvette 217 that is held by the second table unit 207 having been moved to the right end of the slide rail 207a. Also, in the case where the second table unit 207 having moved to the right end of the slide rail 207a is not holding a cuvette 217, the first catcher unit 209 transfers a cuvette 217 stored in the cuvette storing section 208a to the second table unit 207.

The heating table unit 210 is configured to be able to hold the cuvette 217 and to heat, to a predetermined temperature, the sample contained in the cuvette 217. The heating table unit 210 is an annular table provided with a plurality of insertion holes (not shown) for holding cuvettes 217, and is rotatable in the clockwise direction and in the counter clockwise direction. The heating table unit 210 is capable of moving the cuvette 217 in the container position 210a to a container position for heating (not shown) or to a container position 210b. The heating table unit 210 is also provided with a heater (not shown), and thus, the heating table unit 210 is capable of heating the sample contained in the cuvette 217 held by the heating table unit 210.

The second catcher unit 211 is provided at a position surrounded by the annular heating table unit 210, and is configured to be able to transfer a cuvette 217. The second catcher unit 211 is capable of transferring the cuvette 217 from the heating table unit 210 to a position above a first reagent dispensing position 212a, and holding the cuvette 217 at the position. Further, the second catcher unit 211 is capable of transferring the cuvette 217 into which the first reagent has been dispensed, from the position above the first reagent dispensing position 212a to the heating table unit 210. Still further, the second catcher unit 211 is capable of transferring a cuvette 217 stored in the cuvette storing section 208a to the cuvette table 206c.

The third catcher unit 213 is configured to be slidable in the left-right direction on a slide rail 213a that is provided in parallel to the slide rail 207a of the second table unit 207. The third catcher unit 213 is capable of transferring the cuvette 217 in the container position 210b of the heating table unit 210 to a position above a second reagent dispensing position 214a or to a position above a third reagent dispensing position 215a, and holding the cuvette 217 at the position. Further, the third catcher unit 213 is capable of transferring the cuvette 217 to the detection unit 216 from the position above the second reagent dispensing position 214a or from the position above the third reagent dispensing position 215a.

[Configuration of the Reagent Dispensing Unit]

As shown in FIG. 2, the first reagent dispensing unit 212 is configured to be able to dispense the first reagent contained in the first reagent container 212b, into the cuvette 217 that has been transferred, by the second catcher unit 211, to a position above the first reagent dispensing position 212a and held by the second catcher unit 211 at the position.

The second reagent dispensing unit 214 is configured to be able to dispense the second reagent contained in the second reagent container 214b, into the cuvette 217 that has been transferred, by the third catcher unit 213, to a position above the second reagent dispensing position 214a and held by the third catcher unit 213 at the position.

The third reagent dispensing unit 215 is configured to be able to dispense the third reagent contained in the third reagent container 215b, into the cuvette 217 that has been transferred, by the third catcher unit 213, to a position above the third reagent dispensing position 215a and held by the third catcher unit 213 at the position.

[Configuration of the Detection Unit]

As shown in FIG. 2, the detection unit 216 is configured to be able to optically measure the sample, with a reagent added, contained in the cuvette 217 which has been transferred to the detection unit 216 by the third catcher unit 213, thereby detecting optical information about the sample. The detection unit 216 is provided with a plurality of insertion holes (not shown) for cuvettes 217 to be inserted therein. When light is emitted to each of the samples in the cuvettes 217 held in the insertion holes, the detection unit 216 is capable of detecting transmitted light or scattered light, and outputting electrical signals that correspond to the detected transmitted light or scattered light, respectively.

[Configuration of the Information Processing Apparatus]

As shown in FIG. 1, the information processing apparatus is structured as a computer. The information processing apparatus 3 includes a control section 301, a display 302, and an input device 303. The information processing apparatus 3 transmits a measurement start signal to the measurement apparatus 2. Based on identification information received from the measurement apparatus 2, the information processing apparatus 3 inquires of a host computer about a measurement order that contains information such as a measurement item, a determination as to necessity/unnecessity of remeasurement, and the like. The information processing apparatus 3 transmits, to the measurement apparatus 2, information of the measurement item and the determination as to necessity/unnecessity of remeasurement that have been received. The information processing apparatus 3 also analyzes measurement results received from the measurement apparatus 2.

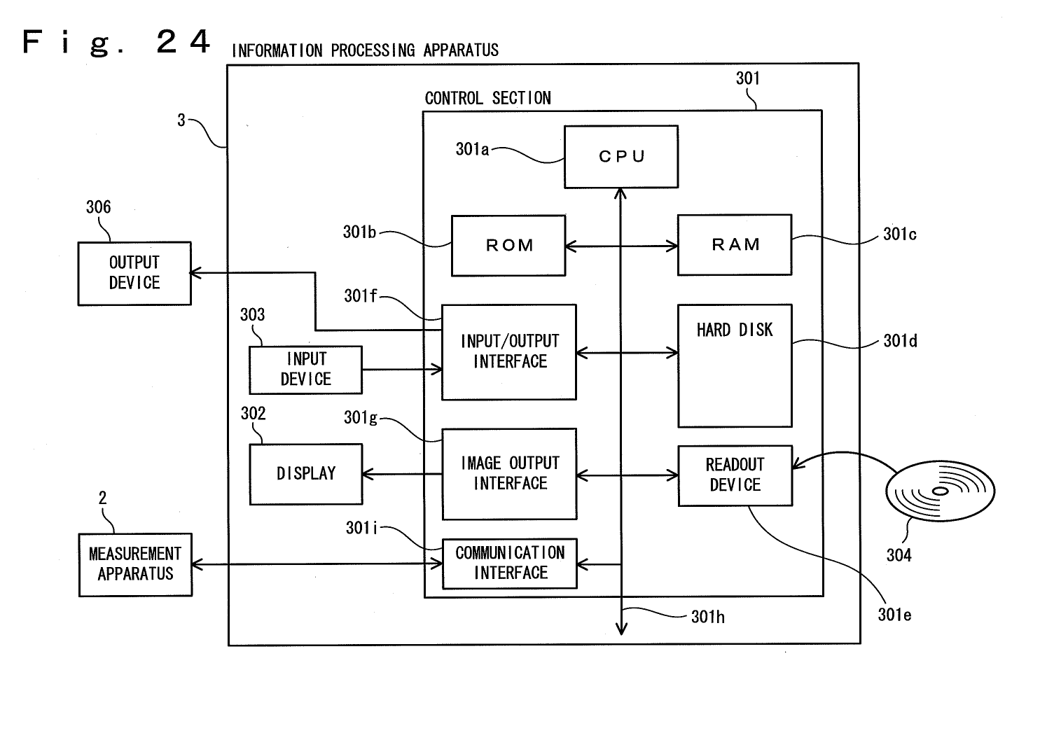

FIG. 24 is a block diagram of the information processing apparatus 3. The control section 301 includes a CPU 301a, a ROM 301b, a RAM 301c, a hard disk 301d, a readout device 301e, an input/output interface 301f, an image output interface 301g, and a communication interface 301i. The CPU 301a, the ROM 301b, the RAM 301c, the hard disk 301d, the readout device 301e, the input/output interface 301f, the image output interface 301g, and the communication interface 301i are connected to each other via a bus 301h.

The CPU 301a is provided so as to execute a computer program stored in the ROM 301b and a computer program loaded into the RAM 301c. The ROM 301b is structured as a mask ROM, a PROM, an EPROM, an EEPROM or the like. The ROM 301b stores, for example, a computer program to be executed by the CPU 301a, and stores data used by the computer program.

The RAM 301c is structured as an SRAM, a DRAM or the like. The RAM 301c is used for reading computer programs stored in the ROM 301b and the hard disk 301d. The RAM 301c is used as a work area of the CPU 301a at the time of execution of these computer programs.

Installed in the hard disk 301d are: various computer programs to be executed by the CPU 301a, such as an operating system and application programs; and data to be used for executing these computer programs.

The readout device 301e is structured as a flexible disc drive, a CD-ROM drive, a DVD-ROM drive or the like. The readout device 301e is capable of reading a computer program or data, which is stored in a portable storage medium 304 or the like.

Also, an operating system that provides a graphical user interface environment, for example, Windows (registered trademark) manufactured and sold by Microsoft Corporation, is installed in the hard disk 301d.

For example, the input/output interface 301f is configured as: a serial interface such as USB, IEEE1394 or RS-232C; a parallel interface such as SCSI, IDE or IEEE1284; or an analogue interface including a D/A converter, an A/D converter and the like. The input device 303 including a keyboard and a mouse is connected to the input/output interface 301f. A user can input data to the information processing apparatus 3, by using the input device 303. The output device 306 including a printer or the like is connected to the input/output interface 301f.

The communication interface 301i is an Ethernet (registered trademark) interface. The information processing apparatus 3 is capable of transmitting/receiving data to/from the measurement apparatus 2 connected thereto by a LAN cable, by means of the communication interface 301i and a predetermined communication protocol (TCP/IP).

The image output interface 301g is connected to the display 302 that is structured with an LCD, a CRT or the like. The image output interface 301g outputs, to the display 302, video signals supplied from the CPU 301a. The display 302 displays an image (a screen), based on the inputted video signals.

[Operations of the Measurement Apparatus and the Information Processing Apparatus]

Next, a brief description is given on operations, to be performed by the measurement apparatus 2, of aspirating the sample from a sample container 401 so as to perform predetermined measurements, and on operations of analyzing the measurement results to be performed by the information processing apparatus 3. Note that the operations described below are performed under control of the CPU 200a of the measurement apparatus 2 and of the CPU 301a of the information processing apparatus 3. Description of operations of the transporting unit 201 is omitted here, and detailed description thereof is given below.

As shown in FIG. 2, following the start of the measurement apparatus 2, first, cuvettes 217 are supplied to the cuvette storing section 208a by the cuvette supplying unit 208. The cuvettes 217 stored in the cuvette storing section 208a are transferred to the second table unit 207 by the first catcher unit 209 and also transferred to the cuvette table 206c by the second catcher unit 211.

When standard measurement is performed, a cuvette 217 on the cuvette table 206c is moved to the container position 206a. The sample is aspirated, by the first dispensing unit 204, from a sample container 401 located at the first sample aspirating position B91. The aspirated sample is discharged into the cuvette 217 located at the container position 206a of the cuvette table 206c.

Subsequently, the cuvette 217, into which the sample has been dispensed at the container position 206a, is moved, by the cuvette table 206c, to the container position 206b. Next, 30% to 40% of the amount of the sample contained in the cuvette 217 moved to the container position 206b is aspirated by the second dispensing unit 205. The aspirated sample is discharged into a cuvette 217 held by the second table unit 207.

On the other hand, when small-amount measurement is performed, the sample is aspirated by the second dispensing unit 205 from a sample container 401 located at the second sample aspirating position B92. The aspirated sample is discharged into a cuvette 217 held by the second table unit 207.

The second table unit 207 moves to the right end of the slide rail 207a. The cuvette 217 held by the second table unit 207 is transferred, by the first catcher unit 209, to the heating table unit 210. Next, the cuvette 217 having been transferred to the heating table unit 210 is transferred, by the second catcher unit 211, to a position above the first reagent dispensing position 212a. Then, the first reagent dispensing unit 212 dispenses the first reagent into the cuvette 217 held by the second catcher unit 211.

After the first reagent is dispensed, the cuvette 217 held at a position above the first reagent dispensing position 212a is transferred again, by the second catcher unit 211, to the heating table unit 210. The heating table unit 210 heats the sample contained in the cuvette 217 for a predetermined period of time.

When the temperature of the sample contained in the cuvette 217 being heated at the heating table unit 210 reaches a predetermined temperature, the second reagent or the third reagent is dispensed into the cuvette 217.

In the case where the second reagent is dispensed, the cuvette 217 is transferred, by the third catcher unit 213, from the container position 210b of the heating table unit 210 to a position above the second reagent dispensing position 214a. The second reagent is dispensed by the second reagent dispensing unit 214 into the cuvette 217.

In the case where the third reagent is dispensed, the cuvette 217 is transferred, by the third catcher unit 213, from the container position 210b of the heating table unit 210 to a position above the third reagent dispensing position 215a. The third reagent is dispensed by the third reagent dispensing unit 215 into the cuvette 217.

Next, the cuvette 217 into which the second reagent or the third reagent has been dispensed is transferred, by the third catcher unit 213, from the position above the second reagent dispensing position 214a or the position above the third reagent dispensing position 215a, to the detection unit 216. Next, optical measurement is performed on the sample in the cuvette 217 by the detection unit 216. The detection unit 216 outputs electrical signals corresponding to transmitted light and scattered light that are detected when light is emitted to the sample contained in the cuvette 217. The measurement apparatus 2 transmits measurement results to the information processing apparatus 3.

The information processing apparatus 3 performs a process of analyzing the measurement results transmitted from the measurement apparatus 2. For example, based on the measured optical information about the scattered light, the transmitted light and the like of each sample, the information processing apparatus 3 calculates an analysis result such as a prothrombin time (PT), fibrinogen (Fbg) or the like of each sample, and causes the display 302 to display the analysis result.

[Operation of the Transporting Unit]

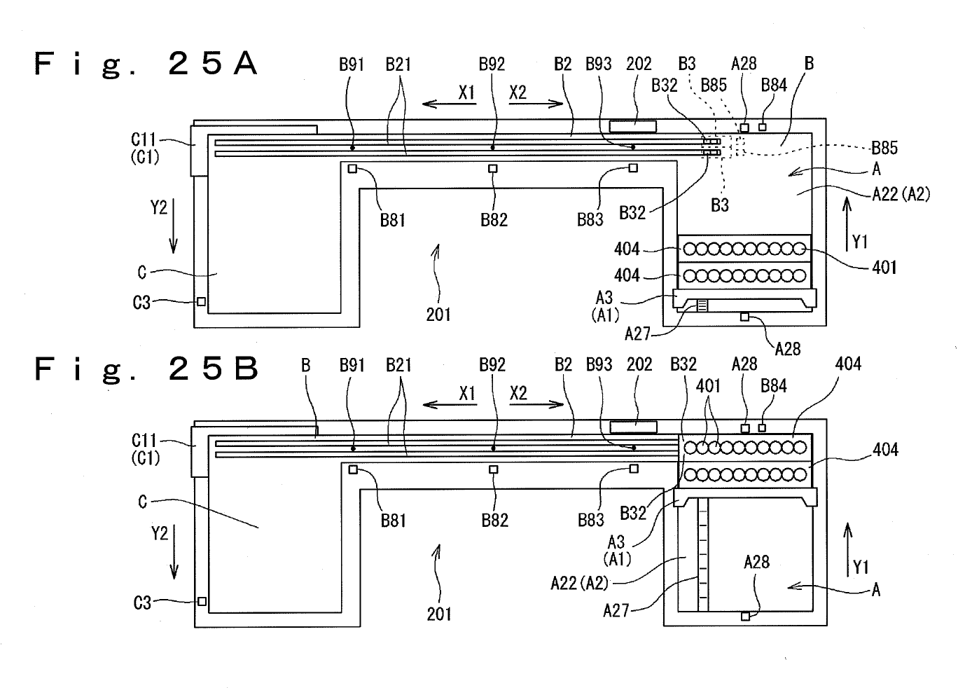

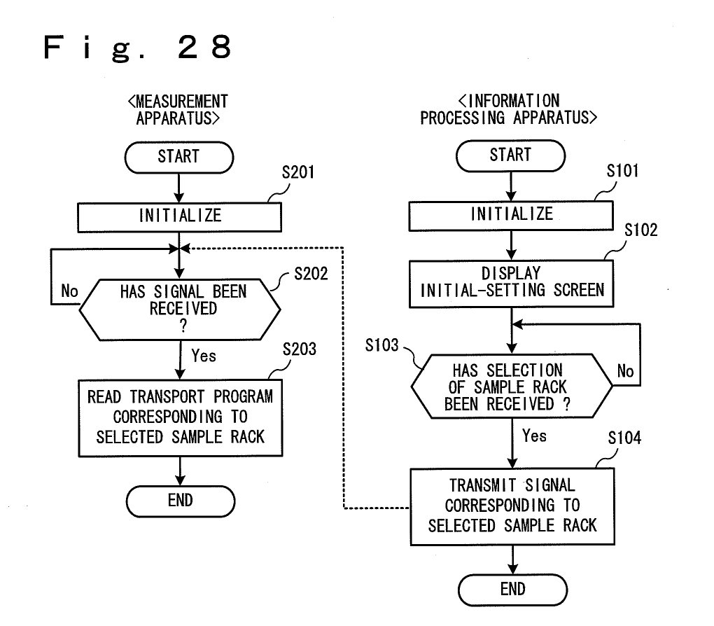

Each of FIG. 28 to FIG. 30 is a flowchart showing the steps of operations of transporting sample racks 404 or 407, the operations being performed by the transporting unit 201. Each of FIG. 25A to FIG. 27B is a schematic plan view showing, in sequence, the operations of transporting the sample racks 404 or 407, the operations being performed by the transporting unit 201. The operations performed by the transporting unit 201 are described with reference to these flowcharts and FIG. 25A to FIG. 27B.

FIG. 28 specifically shows the steps of initial setting for the transporting operations. First, after the measurement apparatus 2 is turned on, the control unit 200 is initialized and operation checks of the respective components of the measurement apparatus 2 are performed, in step S201. After the information processing apparatus 3 is turned on, the information processing apparatus 3 is initialized (initialization of a program) in step S101, and subsequently, an initial-setting screen is displayed on the display 302 (step S102). The initial screen includes, for example, an input screen for inputting various data required for the measurement, and a reception screen for receiving an entry of identification information about the type of the sample rack to be used. The names and the like of the sample racks that can be used are displayed on the reception screen so as to allow a user or a service person to select a sample rack therefrom. However, the present invention is not limited thereto. For example, the name, an identification symbol or the like of the sample rack to be used may be entered via a keyboard 303 or the like.

In step S103, the CPU 301 of the information processing apparatus 3 performs a process of determining whether or not selection of the sample rack 404 or 407 has been received on the initial-setting screen. Upon determination that the selection of the sample rack 404 or 407 has been received (Yes), the CPU 301 advances the processing to step S104. In step S104, the CPU 301 transmits, to the measurement apparatus 2, a signal (identification signal) corresponding to the type of the selected sample rack. And the CPU 301 ends the processing.

Meanwhile, in the measurement apparatus 2, the CPU 200a of the control unit 200 determines whether or not the identification signal for the sample rack 404 or 407 has been received from the information processing apparatus 3 (step S202). Upon determination that the identification signal for the sample rack 404 or 407 has been received (Yes), the CPU 200a advances the processing to step S203. In step S203, the CPU 200a causes a transport program, stored in the ROM 200e and corresponding to the selected sample rack, to be loaded into the RAM 200c. And the CPU 200a ends the processing.

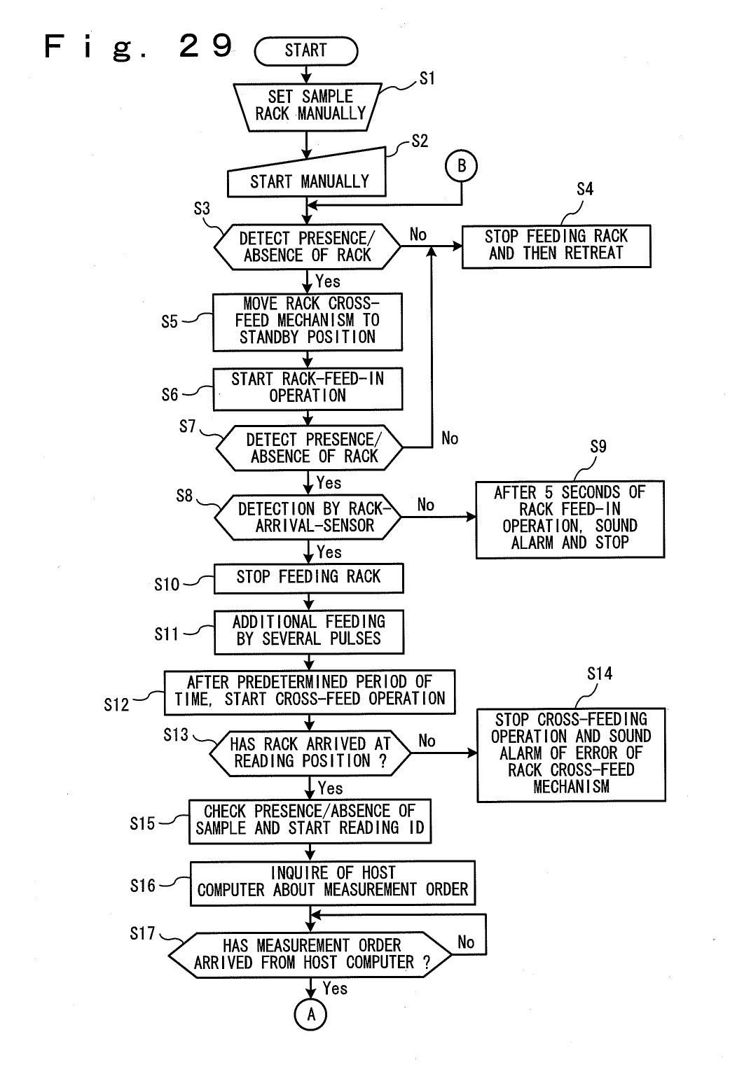

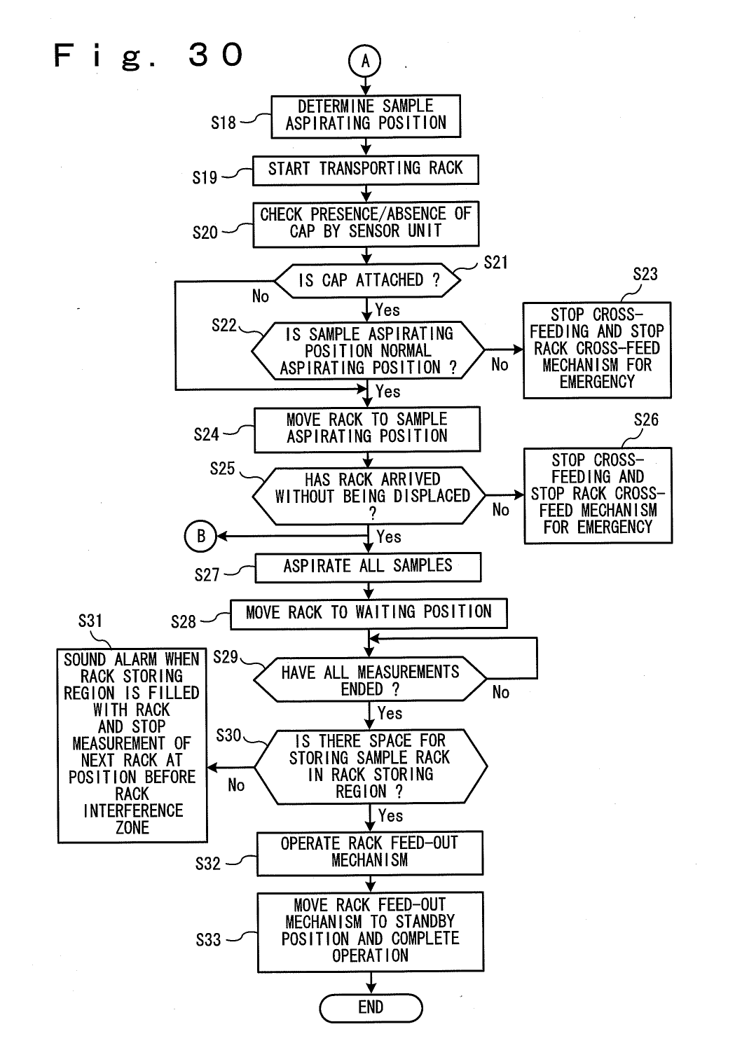

After the above steps have been performed, steps shown in FIG. 29 and FIG. 30 are performed. Hereinafter, description is given on the case where the 10-sample rack 404 has been selected. When the 5-sample rack 407 is selected, the guide member A25 is attached in advance to the placing platform A2 before the measurement is started.

In step S1 of FIG. 29, a user manually sets, on the transporting unit 201, sample racks 404 each holding sample containers 401. Each of FIG. 25A and FIG. 25B shows a state where two sample racks 404 are set in the rack set region A. Next, in step S2, the user manually starts the measurement apparatus 2 and the information processing apparatus 3 (measurement starting operation).

In step S3, the CPU 200a of the measurement apparatus 2 performs a process of making a determination of presence/absence of a sample rack 404 in the rack set region A of the transporting unit 201. This process is performed based on whether or not a sample rack 404 has been detected by the detection sensor A28. Upon determination that there is no sample rack 404 in the rack set region A (No), the CPU 200a advances the processing to step S4, in which the CPU 200a performs a process of causing the rack feed-in mechanism A1 to stop the rack feed-in operation and causing the feed-in member A3 to retreat in a direction opposite to the Y1 direction (Y2 direction).

Upon determination that there is a sample rack 404 in the rack set region A (Yes), the CPU 200a advances the processing to step S5, in which the CPU 200a performs a process of causing the engagement unit B3 of the rack cross-feed mechanism B1 to move, in the transport region B, to the movement start point (standby position). FIG. 25A shows a state where the engagement unit B3 has been returned to the movement start point.

Subsequently, in step S6, the CPU 200a performs a process of causing the rack feed-in mechanism A1 to start transportation of the sample racks 404 that have been set in the rack set region A. As shown in FIG. 25A, this transportation is performed by the feed-in member A3 contacting the end face, on the upstream side in the Y1 direction, of the sample rack 404 located on the most upstream side in the Y1 direction, and by the feed-in member A3 moving in the Y1 direction.

Subsequently, in step S7, the CPU 200a performs again the process of making a determination of presence/absence of a sample rack 404 in the rack set region A of the transporting unit 201. This process is performed so as to deal with such a case where the user has removed, from the rack set region A, a sample rack 404 being transported by the rack feed-in mechanism A1. Upon determination that there is no sample rack 404 in the rack set region A (No), the CPU 200a advances the processing to step S4. In step S4, after having caused the rack feed-in mechanism A1 to stop the rack feed-in operation, the CPU 200a causes the feed-in member A3 to retreat in the direction opposite to the Y1 direction (Y2 direction).

Upon determination, in step S7, that there is a sample rack 404 in the rack set region A (Yes), the CPU 200a advances the processing to step S8. In step S8, the CPU 200a performs a process of determining whether or not a sample rack 404 has been detected by the detection sensor (rack arrival sensor) B84. Upon determination that no sample rack 404 has been detected by the detection sensor B84 (No), the CPU 200a advances the processing to step S9. Whereas, upon determination that a sample rack 404 has been detected by the detection sensor B84 (Yes), the CPU 200a advances the processing to step S10.

In step S9, the CPU 200a performs a process of causing the rack feed-in mechanism A1 to stop the feed-in operation for feeding the sample racks 404, and of sounding, after several seconds (for example, after 5 seconds), an alarm indicating an error in the feed-in operation.

In step S10, the CPU 200a performs a process of causing the rack feed-in mechanism A1 to stop the feed-in operation for feeding the sample racks 404.

Subsequently, in step S11, the CPU 200a performs a process of causing the rack feed-in mechanism A1 to perform an additional feed-in operation for feeding the sample racks 404. This operation is performed by rotating, by several pulses, the electric motor A43 of the movement mechanism A4, whereby a sample rack 404 is completely fed into the transport region B. FIG. 25B shows a state where the sample rack 404 located in the most downstream side in the Y1 direction has been completely fed into the transport region B.

Subsequently, in step S12, when a predetermined period of time has elapsed after the sample rack 404 is completely fed into the transport region B, the CPU 200a performs a process of causing the rack cross-feed mechanism B1 to start an operation of transporting the sample rack 404, thereby moving the sample rack 404 toward the bar code reading position B93.

This operation is performed in the following manner: first, as shown in FIG. 17 and FIG. 18, the air cylinder B33a of one engagement unit B3 is operated; the engagement claws B32a of the pair of the engagement members B32 of the engagement unit B3 are caused to ascend so as to advance into a recess 404b provided in the bottom of the sample rack 404; the pair of the engagement claws B32a are caused to separate from each other so as to contact the opposing wall portions 404c and 404d of the recess 404b. Accordingly, the pair of the engagement members B32 are closely engaged with the sample rack 404, without leaving space therebetween in X1 and X2 directions, and thus securely hold the sample rack 404. Then, the electric motor B43 (see FIG. 15) of the movement mechanism B4 is rotated by a predetermined number of pulses so as to move the engagement unit B3 in the X1 direction, whereby the sample rack 404 is transported.

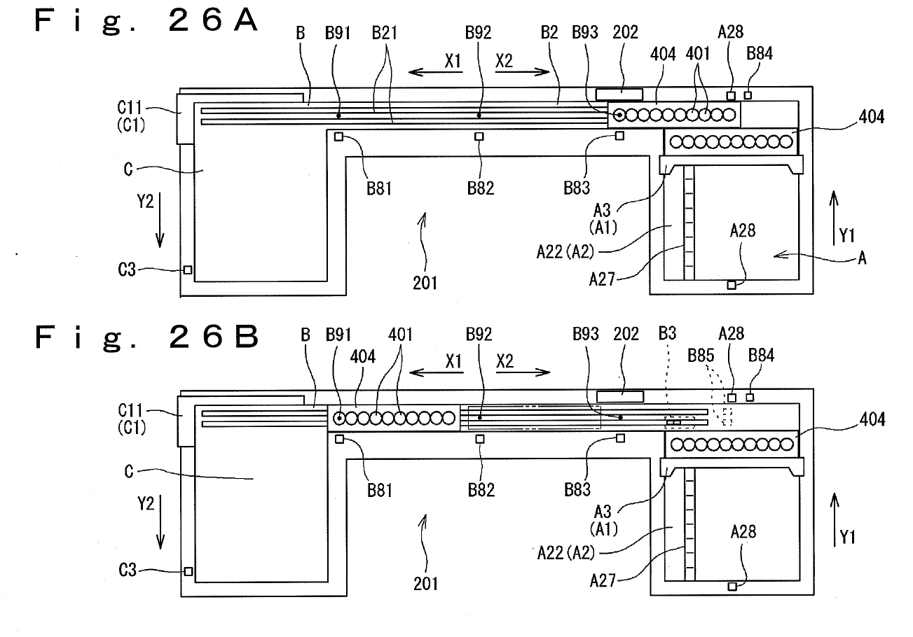

In step S13, the CPU 200a performs a process of determining whether or not the sample rack 404 has been transported to the bar code reading position B93 at which the bar code reading is performed by the bar code reader unit 202. This determination is made based on whether or not the sample rack 404 has been detected by the detection sensor B83. FIG. 26A shows a state where the left-most sample container 401 existing in the sample rack 404 is located at the bar code reading position B93.

Upon determination that the sample rack 404 has been transported to the bar code reading position B93 at which the bar code reading is performed by the bar code reader unit 202 (Yes), the CPU 200a advances the processing to step S15. Whereas, upon determination that the sample rack 404 has not been transported to the bar code reading position B93 (No), the CPU 200a advances the processing to step S14.

In step S14, the CPU 200a performs a process of causing the movement mechanism B4 of the rack cross-feed mechanism B1 to stop the operation and of sounding an alarm indicating an error.

In step S15, the CPU 200a performs a process of causing the bar code reader unit 202 to read the bar code 405 attached to the sample rack 404 and the bar codes 402 attached to all the sample containers 401, respectively. In the present embodiment, the pair of the engagement members B32 of the engagement unit B3 of the rack cross-feed mechanism B1 are closely engaged with a recess 404b of the sample rack 404, without leaving space therebetween in the X1 and X2 directions. This allows the sample rack 404 to be transported little by little with enhanced accuracy, thereby allowing the bar code reader unit 202 to accurately read the bar codes 405 and 402 in this transporting process. In the present embodiment, the bar code reader unit 202 reads each bar code 405 and 402 four times during the transportation of the sample rack 404, thereby providing further enhanced accuracy.

Subsequently, in step S16, the CPU 200a performs a process of transmitting, to the host computer, the information read by the bar code reader unit 202 and inquiring measurement orders. In the host computer, a measurement order of the sample contained in each sample container 401 held in the sample rack 404 is registered. The measurement order contains information, such as measurement items and whether or not to perform a reflex test. The host computer transmits the measurement orders in accordance with the inquiry from the CPU 200a.

In step S17, the CPU 200a performs a process of determining whether or not the measurement orders have been transmitted from the host computer. Upon determination that the measurement orders have been transmitted, the CPU 200a advances the processing to step S18.

In step S18 of FIG. 30, the CPU 200a performs, based on the measurement orders received in step S17, a process of determining to which of the first sample aspirating position B91 and the second sample aspirating position B92 to move a sample container 401 held in the rack 404. In step S19, the CPU 200a performs a process of causing the rack cross-feed mechanism B1 to start the operation of cross-feeding the rack 404.

In step S20, the CPU 200a performs a process of causing the sensor unit 203 to check whether or not the cap 403 is attached to the sample container 401 passing below the sensor unit 203. In step S21, the CPU 200a performs, based on the result of the process of step S20, a process of determining whether or not the cap 403 is attached to the sample container 401.

Upon determination, in step S21, that the cap 403 is attached to the sample container 401 (Yes), the CPU 200a performs, in step S22, a process of determining whether or not the sample aspirating position, for the sample container 401 with the cap 403 attached, that has been determined in the process of step S18 is the first sample aspirating position (normal aspirating position) B91.

Upon determination, in step S22, that the sample aspirating position for the sample container 401 is not the first sample aspirating position B91 (No), the CPU 200a performs, in step S23, a process of causing the rack cross-feed mechanism B1 to stop the transportation. In this case, the CPU 200a stops the electric motor B43 of the movement mechanism B4 so as to stop the movement of the engagement unit B3, and at the same time, the CPU 200a stops the supply of compressed air to the air cylinder B33a of the engagement unit B3.

Upon determination, in step S21, that the cap 403 is not attached to the sample container 401 (No), or upon determination, in step S22, that the sample aspirating position for the sample container 401 is the first sample aspirating position B91 (Yes), the CPU 200a performs, in step S24, a process of causing the rack cross-feed mechanism B1 to transport the sample container 401 held in the sample rack 404 to the first sample aspirating position B91 or the second sample aspirating position B92, in accordance with the measurement order for the sample container 401. FIG. 26B shows a state where the left-most sample container 401 existing in the sample rack 404 is located at the first sample aspirating position B91.

For example, in the case where the measurement orders are: performing standard measurement on the first sample container 401 (left-most sample container 401) in the sample rack 404; performing small-amount measurement on the second sample container 401; and performing standard measurement on the third sample container 401, the rack cross-feed mechanism B1 transports the sample rack 404 in such a manner as to: locate the first sample container 401 at the first sample aspirating position B91; locate the second sample container 401 at the second sample aspirating position B92; and locate the third sample container 401 at the first sample aspirating position B91.

In this case, the rack cross-feed mechanism B1 transports the sample rack 404, in the X1 direction, from the bar code reading position B93 to the first sample aspirating position B91; subsequently, in the X2 direction, from the first sample aspirating position B91 to the second sample aspirating position B92; and subsequently, in the X1 direction, from the second sample aspirating position B92 to the first sample aspirating position B91. In other words, the rack cross-feed mechanism B1 transports the sample rack 404 between the first sample aspirating position B91 and the second sample aspirating position B92 in a reciprocating manner.

In the present embodiment, the pair of the engagement members B32 of the engagement unit B3 of the rack cross-feed mechanism B1 are closely engaged with a recess 404b of the sample rack 404, without leaving space therebetween in the X1 and X2 directions. Accordingly, although the sample rack 404 is transported in a reciprocating manner between the first sample aspirating position B91 and the second sample aspirating position B92 as described above, the transporting pitch is not varied. Therefore, it is possible to locate, in a direct and accurate manner, each sample container 401 held in the sample rack 404 to the sample aspirating position B91 or B92.

In step S25, the CPU 200a performs a process of determining whether or not the sample container 401 has arrived at the predetermined sample aspirating position B91 or B92 without being displaced. This process is performed based on whether or not the sample container 401 has been detected by the detection sensor B81 or B82 provided corresponding to the sample aspirating position B91 or B92. Alternatively, the process is performed based on whether or not the electric motor B43 of the movement mechanism B4 has been operated by the number of pulses corresponding to the distance for the sample container 401 to be transported. Upon determination that the sample container 401 has arrived at the predetermined sample aspirating position B91 or 392 without being displaced (Yes), the CPU 200a advances the processing to step S27. Upon determination that the sample container 401 has not arrived at the predetermined sample aspirating position B91 or B92 (No), the CPU 200a advances the processing to step S26.

In step S26, the CPU 200a performs a process of causing the rack cross-feed mechanism B1 to stop the transportation. In this case, the CPU 200a stops the electric motor B43 of the movement mechanism B4 so as to stop the movement of the engagement unit B3, and the CPU 200a stops the supply of compressed air to the air cylinder B33a of the engagement unit B3. This causes the rod B33c of the air cylinder B33a to descend, thereby causing the pair of the engagement members B32 to be disengaged from the sample rack 404 and to retreat below the transporting path B22 in the transport region B. Accordingly, the user can easily remove, at the time of emergency, the sample rack 404 from the transport region B.

In step S27, the CPU 200a performs a process of causing the first dispensing unit 204 or the second dispensing unit 205 to aspirate the sample from the sample container 401 located at the first sample aspirating position B91 or the second sample aspirating position B92. Further, before the first dispensing unit 204 or the second dispensing unit 205 has completed the process of aspirating the samples from all the sample containers 401 (before all the processes to be performed in step S27 are completed), the CPU 200a starts the processes of step S3 and thereafter in FIG. 29, onto the subsequent sample rack 404 standing by in the rack set region A.

Specifically, in the present embodiment, provision of two rack cross-feed mechanisms B1 in the transport region B allows concurrent transportation of two sample racks 404. Therefore, it is possible to cause one rack cross-feed mechanism B1 to perform the operations necessary for the samples to be aspirated from the sample containers 401, and it is possible to cause the other rack cross-feed mechanism B1 to perform the operations necessary for the bar code reader unit 202 to read the bar code 405 attached to the sample rack 404 and the bar codes 402 attached to the sample containers 401.

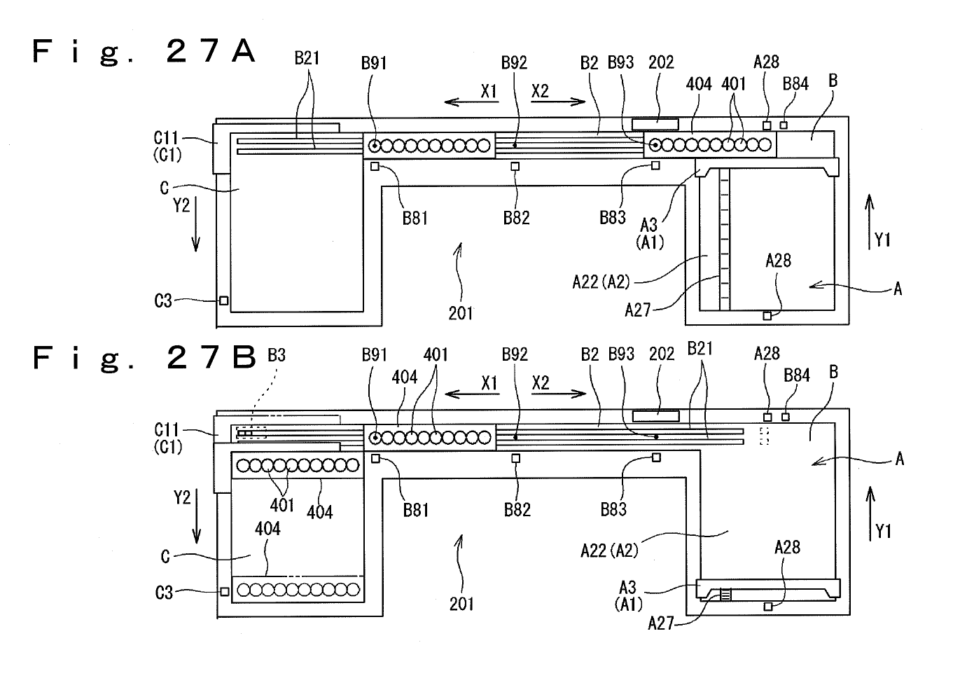

Note that, the CPU 200a performs, with respect to the subsequent sample rack 404, processes that do not interfere with the operations of aspirating the samples being performed with respect to the preceding sample rack 404. Specifically, the CPU 200a performs the processes from the reading of the bar code 405 of the sample rack 404 and the bar codes 402 of the sample containers 401, to the inquiring of the host computer about measurement orders (steps S3 to S17). FIG. 27A shows a state where both sample racks 404 are being transported.

Subsequently, in step S28, the CPU 200a causes the sample rack 404 from which the samples have been aspirated, to be transported to a waiting position, which is the end point (left end) in the X1 direction.

Subsequently, in step S29, the CPU 200a performs a process of determining whether or not all the measurement has been ended with respect to the samples aspirated by the first dispensing unit 204 and the second dispensing unit 205 and corresponding measurement results have been obtained. Upon determination that all the measurement results have been obtained, the CPU 200a advances the processing to step S30.

In step S30, the CPU 200a performs a process of determining whether or not there remains space for storing sample racks 404 in the rack storing region C. This process is performed based on whether or not a sample rack 404 has been detected, by the detection sensor C3, at the downstream end in the Y2 direction in the rack storing region C. Since, in the rack storing region C, sample racks 404 are each transported, pitch by pitch, in the Y2 direction, existence of a sample rack 404 in the downstream end in the Y2 direction means that the rack storing region C is filled with sample racks 404.

Upon determination that there remains space for storing sample racks 404 in the rack storing region C (Yes), the CPU 200a advances the processing to step S32. Upon determination that the space for storing sample racks 404 does not remain (No), the CPU 200a advances the processing to step S31. In step S31, the CPU 200a performs a process of sounding an alarm indicating an error that the rack storing region C is filled with the sample racks 404. Further, the CPU 200a performs a process of causing the rack cross-feed mechanism B1 to stop the subsequent sample rack 404 at a position at which the subsequent sample rack 404 does not interfere with the preceding sample rack 404 thereof (for example, the first sample aspirating position B91).

In step S32, the CPU 200a performs a process of causing the feed-out member C11 of the rack feed-out mechanism C1 to move in the Y2 direction, so as to feed out the sample rack 404 in the Y2 direction. Subsequently, in step S33, the CPU 200a causes the feed-out member C11 of the rack feed-out mechanism C1 to be returned to the standby position, and the CPU 200a ends the operation. FIG. 27B shows a state where the preceding sample rack 404 has been fed out by one pitch in the Y2 direction and where the subsequent sample rack 404 has been located at the first sample aspirating position B91 for the operation of aspirating the sample.

As described above, the sample analyzer 1 of the present embodiment is capable of using a plurality of types of the sample racks, such as the 10-sample rack 404 and the 5-sample rack 407 each having a different length. This allows the sample racks used in the sample analyzer 1 of the present embodiment to be used in other sample analyzers, thereby providing enhanced convenience. Also, a manufacturer of sample analyzers need not separately design And manufacture transporting units 201 corresponding to a plurality of types of the sample racks, respectively. Therefore, it is possible to reduce the development costs and the manufacturing costs.

In the rack set region A, on the transporting path A22 of the placing platform A2, the guide members A23 are provided for transporting the 10-sample rack 404, and the guide members A23 and A25 are provided for transporting the 5-sample rack 407. Accordingly, the sample analyzer 1 of the present embodiment is capable of smooth transportation of the sample rack 404 and of the sample rack 407. Moreover, the guide member A25 for the 5-sample rack 407 is attached to the placing platform A2 in a detachable manner. Accordingly, it is possible to prevent the guide member A25 from interfering with the 10-sample rack 404 when the 10-sample rack 404 is being transported.

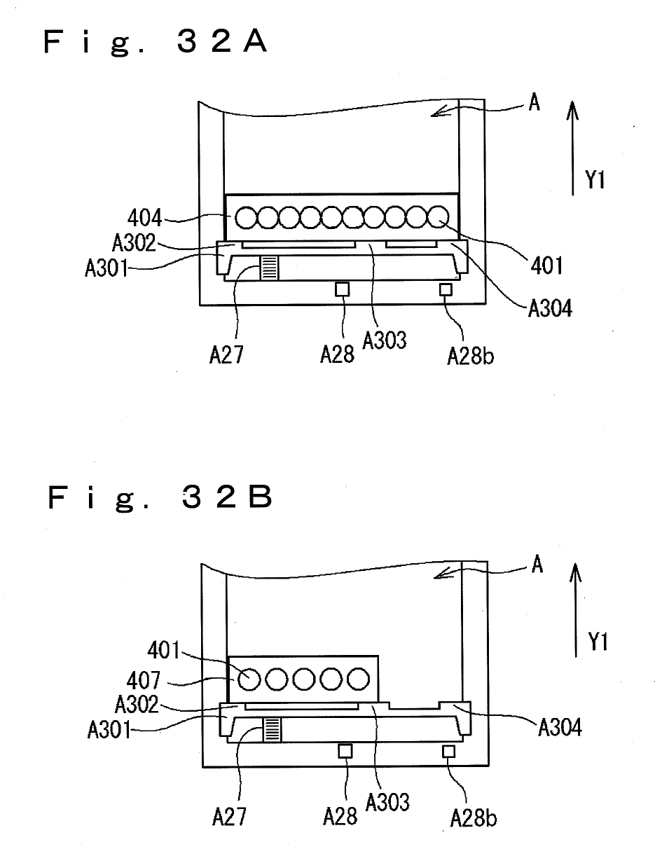

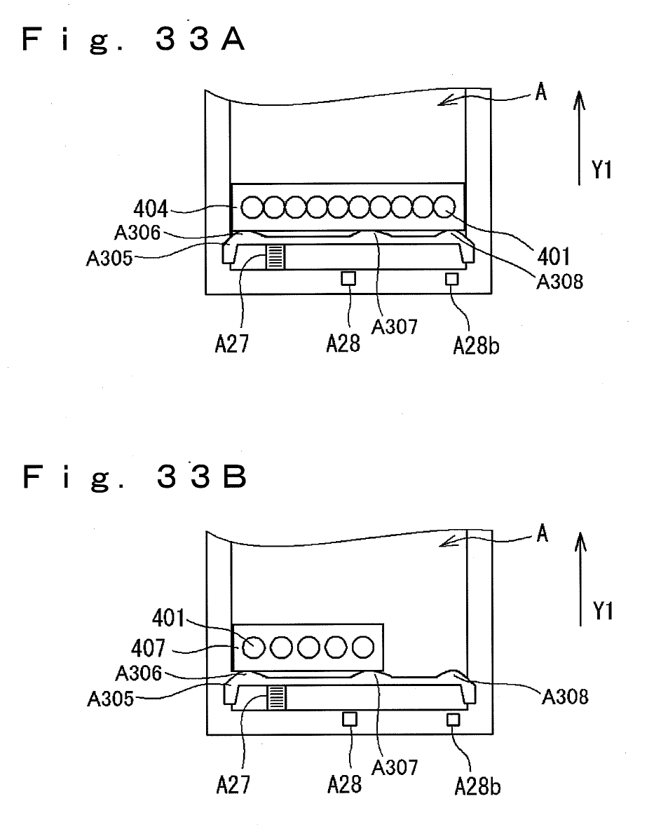

The feed-in member (transporting member) A3 of the rack feed-in mechanism A1 extends over the longitudinal length of the 10-sample rack 404. Accordingly, the sample analyzer 1 of the present embodiment is capable of transporting not only the 10-sample rack 404 but also the 5-sample rack 407. That is, one feed-in member A3 enables the transportation of a plurality of types of the sample racks, that is, the sample racks 404 and 407. Accordingly, it is possible to realize a simpler configuration of the sample analyzer 1 than that in the case where separate feed-in members A3 are provided so as to correspond to the respective types of the sample racks. Note that, the separate feed-in members A3 may be provided so as to correspond to the respective types of the sample racks. Also, the feed-in member A3 is not limited to the one having the shape that continuously extends in the longitudinal direction of the 10-sample rack 404. The feed-in member A3 may be provided in a shape having protrusions 302, 303, and 304 that contact the sample rack 404 or 407 at a plurality of positions in the longitudinal direction thereof, as in the feed-in member A301 shown in FIG. 32A and FIG. 32B. Each of the protrusions provided on the feed-in member A301 shown in FIG. 32A and FIG. 32B has a flat surface at the portion contacting the sample rack 404 or 407. However, each of the protrusions provided in the feed-in member A301 may, as in the feed-in member A305 shown in FIG. 33A and FIG. 33B, have a curved shape at the portion contacting the sample rack 404 or 407. Note that, in the case of the feed-in member A301 shown in FIG. 32A and FIG. 32B or the feed-in member A305 shown in FIG. 33A and FIG. 33B, the protrusions are preferably provided at positions corresponding to both end portions of the sample rack.

Note that, the feed-in member A3 may be supported, for example, by a support member that penetrates a slit, the support member moving in the front-rear direction. The slit is formed in the transporting path A22 and extends in the front-rear direction. However, as in the present embodiment, by supporting the feed-in member A3 at the positions outside the left and right ends of the placing platform A2, it is possible to simplify the structure of the placing platform A2, without the necessity of forming a slit in the transporting path A22. In the case where a slit is formed in the transporting path A22, if the sample is spilt onto the transporting path A22, the sample is also spilt onto the movement mechanism A4 and the like, which are provided below the transporting path A22, thereby causing a possibility of breakdown. However, in the present embodiment, such a problem does not occur.

In the sample analyzer 1 of the present embodiment, the rack cross-feed mechanism B1 of the transporting unit 201 includes a pair of engagement members B32 that are to be engaged with the sample rack 404 or 407 through a separating action performed by the pair of the engagement members B32. When the pair of the engagement members B32 are engaged with the recess 404b formed in the sample rack 404 or 407, no space is left between the pair of the engagement members B32 and the recess 404b, with respect to the X1 and X2 directions. This allows the transporting unit 201 to transport the sample rack 404 or 407 such that the sample rack 404 or 407 follows the movement of the pair of the engagement units B3 with high accuracy. Therefore, whether the transporting unit 201 transports the sample rack 404 (407) in the X1 direction or in the X2 direction, the transporting pitch can be assuredly maintained. Accordingly, even when a user causes the transporting unit 201 to transport the sample rack 404 or 407 between the first sample aspirating position B91 and the second sample aspirating position B92 in a reciprocating manner, so as to perform standard measurement and small-amount measurement, the transporting unit 201 can accurately locate the sample container 401 at the aspirating position B91 or B92.

Further, the pair of the engagement members B32 are engaged with the recess 404b of the sample rack 404 or the recess 407b of the sample rack 407, without leaving space therebetween in the X1 and X2 directions, and thus substantially holding the sample rack 404 or 407. This reduces tilting, in the front-rear direction, of the sample rack (rocking of the sample rack 404 or 407 in the upstream portion thereof) during the transportation thereof. Accordingly, each engagement member B32 may be formed from a plate material which is thin in the front-rear direction, thereby allowing a compact structure of the engagement unit B3 having a small dimension in the front-rear direction. This makes it possible to arrange two rack cross-feed mechanisms B1 in parallel in the front-rear direction.

Moreover, the pair of the engagement members B32 of the engagement unit B3 are configured to separate from each other while ascending, so as to be engaged with the recess 404b of the sample rack 404 or the recess 407b of the sample rack 407. In a state before the pair of the engagement members B32 advance into the recess 404b or 407b, the width in the left-right direction of the pair of the engagement members B32, the width being measured between the portions that are to be engaged with the recess 404b or 407b, is smaller than the interval between the opposing wall portions 404c and 404d of the recess 404b or 407b. In a state after the pair of the engagement members B32 have advanced into the recess 404b or 407b, the width described above in the left-right direction of the pair of the engagement members B32 is enlarged so that the pair of the engagement members B32 can contact the wall portions 404c and 404d. Accordingly, in the sample analyzer 1, it is possible to cause the pair of the engagement members B32 to assuredly advance into the recess 404b or 407b and subsequently to cause the pair of the engagement members B32 to be engaged with the recess 404b or 407b, without leaving space therebetween in the X1 and X2 directions. Moreover, as shown in FIG. 5 and FIG. 7, the pair of the engagement members B32 are capable of being engaged with the sample rack 404 and with the sample rack 407, the sample rack 404 and the sample rack 407 each having a recess of a different shape and different dimensions.

Moreover, the pair of the engagement members B32 are provided on the base body B31 in a rotatable manner. Accordingly, the pair of the engagement members B32 are capable of concurrently performing two types of actions, that is, the approaching/separating actions and the ascending/descending actions, through a simple structure. Moreover, the pair of the engagement members B32 are capable of performing these actions via one air cylinder B33a. Accordingly, the structure of the engagement unit B3 is substantially simplified.

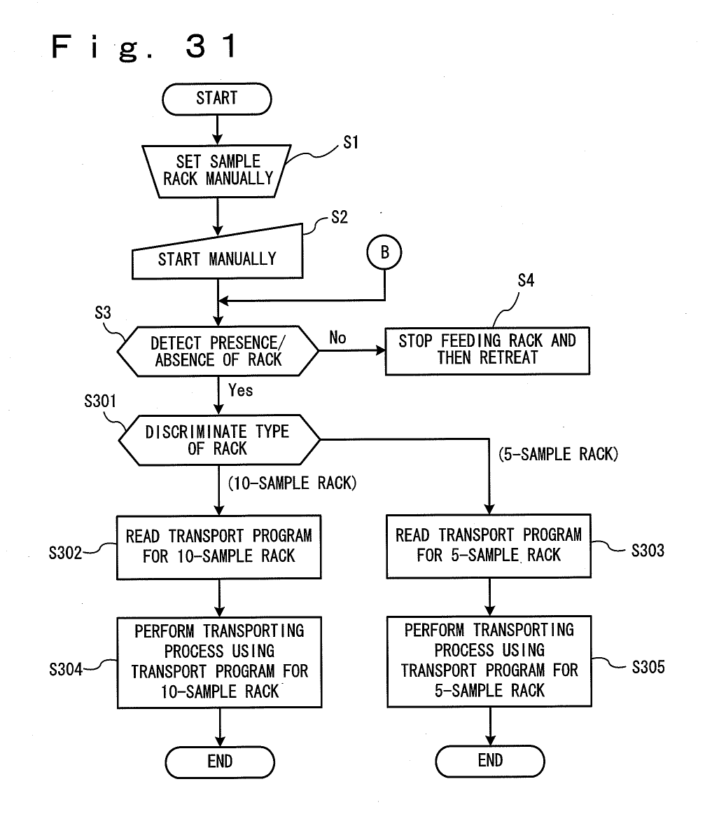

FIG. 31 is a flowchart showing steps of transporting operations performed by a sample analyzer according to a second embodiment of the present invention. In the first embodiment described above, the display 302 of the information processing apparatus 3 is configured to display an initial-setting screen so as to allow the entry (selection) of the type of the sample rack (404 or 407) that is to be used. However, the present embodiment employs a method in which the type of the sample rack (404 or 407) is discriminated in the rack set region A, and a corresponding transport program is selected based on the result.

For example, a method described below can be employed for discriminating the type of the sample rack (404 or 407). In the method, as shown in FIG. 9A to FIG. 10B, a detection sensor A28b including a transmission type photo sensor or the like is provided in the rack set region A. The CPU 200a determines that a 10-sample rack 404 is set in the rack set region A when emitted light is blocked for both the detection sensor A28 and the detection sensor A28b described above; and the CPU 200a determines that a 5-sample rack 407 is set in the rack set region A when emitted light is blocked for only the detection sensor A28.

In FIG. 31, the processes from step S1 to step S4 are the same as those described with reference to FIG. 29. In step S301, the CPU 200a of the control unit 200 discriminates the type of the sample rack, based on the detection results obtained by the detection sensors A28 and A28b. Upon determination that the type is the 10-sample rack 404, the CPU 200a advances the processing to step S302. Whereas, upon determination that the type is the 5-sample rack 407, the CPU 200a advances the processing to step S303.

In step S302, the CPU 200a causes a transport program for the 10-sample rack 404 stored in the ROM 200e, to be loaded into the RAM 200c. In step S304, the CPU 200a performs, using the transport program, predetermined transporting processes (processes of steps S5 to S33 shown in FIG. 29 and FIG. 30).

In step S303, the CPU 200a causes a transport program for the 5-sample rack 407 stored in the ROM 200e, to be loaded into the RAM 200c. In step S305, the CPU 200a performs, using the transport program, predetermined transporting processes (processes of steps S5 to S33 shown in FIG. 29 and FIG. 30).

In the present embodiment, it is possible to eliminate the necessity for the user to enter the type of the sample rack 404 or 407 in advance, and to prevent an erroneous entry by the user.

Note that, the present embodiment describes the configuration in which the detection sensor A28 and A28b are used to discriminate the type of the sample rack, the 10-sample rack 404 or the 5-sample rack 407, set in the rack set region A. However, the present invention is not limited thereto. For example, a configuration may be employed in which the bar code reader unit 202 reads a rack bar code (not shown) that contains identification information for identifying the type of the sample rack and that is attached to the sample rack, so as to discriminate the type of the sample rack. Based on the discrimination result, an appropriate transport program is loaded into the RAM 200c. Another configuration may be employed in which a transport program for the 5-sample rack 407 is loaded into the RAM 200c, following the detection of the guide member A25 having been attached onto the placing platform A2, the detection being made when the detection plate A25e blocks emitted light to be received by the detection sensor A26, as shown in FIG. 14.

Further, the detection sensor A28b shown in FIG. 9 and FIG. 10 is also applicable to the transporting unit 201 of the first embodiment. Thus, another configuration may be employed in which: transporting operation is performed only when the type of the sample rack (404 or 407) selected on the reception screen at the initial setting coincides with the detection result obtained by the detection sensors A28 and A28b, and an alarm is sounded when the type of the sample rack (404 or 407) selected on the reception screen at the initial setting does not coincide with the detection result obtained by the detection sensors A28 and A28b, which is determined as an error.

Note that, the present invention is not limited to the above embodiments and other variations can be devised.

For example, in the embodiments described above, the 10-sample rack 404 and the 5-sample rack 407 are given as exemplary types of the sample racks. However, a sample rack that holds a different number of sample containers 401 than that of the 10-sample rack 404 or the 5-sample rack 407, may be used. Further, the transporting apparatus of the present invention may be configured to be able to transport three or more types of sample racks.

The place blocking member A27 for the sample rack 404 or 407, provided on the upstream side in the transporting direction of the feed-in member A3 may not be limited of a bellow-shape in order to be able to expand and contract. The place blocking member A27 may be configured to be of a roll screen type so as to be pulled out and rolled up in accordance with the operation of the feed-in member A3. Further, the place blocking member A27 may not necessarily be able to expand and contract, and may have any configuration only if the place blocking member A27 exists between the feed-in member A3 and the front edge of the rack set region A.

Further, in the embodiment described above, the drive source of the engagement unit B3 is structured as the air cylinder B33a. However, the drive source of the engagement unit B3 may be structured as a hydraulic cylinder B33a or an electromagnetic solenoid. Also in such a case, when an error has occurred during the transportation of the sample rack 404, it is possible, by turning off the power of the drive source, to disengage the pair of the engagement members B32 from the sample rack 404, thereby enabling the user to easily remove the sample rack from the transport region B.

Further, the pair of the engagement members B32 of the engagement unit B3 may be configured to come into engagement with the sample rack 404 by approaching each other. In this case, the pair of the engagement members B32 may advance into two adjacent recesses 404b of the sample rack 404, respectively, so as to come into engagement with the wall portion 404d existing between these two recesses 404b, in such a manner as to pinch the wall portion 404d. However, if the pair of the engagement members B32 are engaged with the sample rack 404 by separating from each other, as in the embodiments described above, it is possible for the pair of the engagement members B32 to be engaged with a sample rack having only one recess formed therein (for example, the sample rack 407 of FIG. 7).

In the embodiments described above, two rack cross-feed mechanisms B1 are arranged in parallel in the front-rear direction. However, three or more rack cross-feed mechanisms B1 may be arranged if there is space for arrangement thereof. Alternatively, a configuration may be employed in which only one rack cross-feed mechanism B1 is provided. Further, in the embodiments described above, two sample aspirating positions 391 and B92 are provided. However, only one sample aspirating position or three or more sample aspirating positions may be provided.

In the embodiments described above, the measurement orders are registered in the host computer by the user. However, the present invention is not limited thereto. Alternatively, the measurement order may be registered in the information processing apparatus 3 by the user.

In the embodiments described above, the sample analyzer is configured as a blood coagulation measuring apparatus. However, the present invention is not limited thereto. Alternatively, the sample analyzer may be configured as a blood cell counter, an immunoanalyzer, or a biochemical analyzer. Further, in the embodiments described above, the transporting unit is provided in the sample analyzer. However, the present invention is not limited thereto. Alternatively, for example, the transporting unit may be provided in a smear preparing apparatus.

In the embodiments described above, the control unit provided in the measurement apparatus controls the operation of the transport mechanism in the transporting unit. However, the present invention is not limited thereto. A control unit that is different from the control unit provided in the measurement apparatus may be provided in the transporting unit, and may control the operation of the transport mechanism of the transporting unit.

What is claimed is:

1. A transporting apparatus for transporting a sample rack capable of holding a plurality of sample containers comprising:
a transporting path that has a width allowing placing of each of a first sample rack and a second sample rack having a length in longitudinal direction greater than that of the first sample rack, the transporting path extending in a transporting direction intersecting the longitudinal direction of the first sample rack or the second sample rack placed on the transporting path; and
a transport mechanism configured for transporting each of the first sample rack and the second sample rack placed on the transporting path in the transporting direction.

2. The transporting apparatus of claim 1, wherein the transport mechanism comprises:
a transporting member for contacting with a face of the first sample rack or the second sample rack placed on the transporting path on an upstream side in the transporting direction; and
a movement mechanism for moving the transporting member in the transporting direction, and wherein
the transporting member comprises a portion capable of contacting with each of the first sample rack and the second sample rack.

3. The transporting apparatus of claim 2, wherein
the transporting member has a length that allows the transporting member to contact with the second sample rack, along a whole of the longitudinal length of the second sample rack.

4. The transporting apparatus of claim 1, further comprising:
a first guide member for guiding transportation of the first sample rack; and
a second guide member for guiding transportation of the second sample rack.

5. The transporting apparatus of claim 4, wherein
the transporting path comprises an attachment portion for detachably attaching the first guide member to the transporting path.

6. The transporting apparatus of claim 2, further comprising:
a place blocking member for preventing each of the first sample rack and the second sample rack from being placed on the transporting path on the upstream side of the transporting member in the transporting direction.

7. The transporting apparatus of claim 1, further comprising:
a second transporting path connected to a transport end portion of the transporting path and extending in a second transporting direction intersecting the transporting direction; and
a second transport mechanism for transporting each of the first sample rack and the second sample rack supplied on the second transporting path in the second transporting direction.

8. The transporting apparatus of claim 7, wherein the second transporting path comprises:
a restricting portion arranged along the second transporting direction, for restricting movement of each of the first sample rack and the second sample rack in a direction perpendicular to the second transporting direction.

9. The transporting apparatus of claim 7, wherein the second transport mechanism comprises:
an engagement unit being capable of engaging with each of the first sample rack and the second sample rack; and
a second movement mechanism for moving the engagement unit in the second transporting direction, wherein the engagement unit comprises:
a pair of engagement members, capable of mutually approaching and separating with respect to the second transporting direction, and engaging with each of the first sample rack and the second sample rack gaplessly with respect to the second transporting direction by the approaching action or the separating action; and
a drive section for driving the pair of the engagement members so as to perform the approaching action and the separating action.

10. The transporting apparatus of claim 9, wherein
the first sample rack comprises a first recess on a bottom face thereof,
the second sample rack comprises a second recess having a shape different from that of the first recess on a bottom face thereof, and
the engagement members engage with each of the first recess of the first sample rack and the second recess of the second sample rack gaplessly with respect to the second transporting direction by the approaching action or the separating action.

11. The transporting apparatus of claim 7, further comprising:
an obtainer for obtaining identification information for identifying a type of the first sample rack or the second sample rack to be transported by the second transport mechanism; and
a transport controller for controlling the second transport mechanism in accordance with the type of the first sample rack or the second sample rack, based on the identification information obtained by the obtainer.

12. The transporting apparatus of claim 7, further comprising:
a discriminator for discriminating a type of the first sample rack or the second sample rack to be transported by the second transport mechanism; and
a transport controller for controlling the second transport mechanism in accordance with the type of the first sample rack or the second sample rack discriminated by the discriminator.

13. The transporting apparatus of claim 12, further comprising:
a first rack detection sensor provided at a position that allows detection of each of the first sample rack and the second sample rack placed on the transporting path; and
a second rack detection sensor provided at a position that allows detection of only the second sample rack placed on the transporting path, wherein
the discriminator discriminates the type of the first sample rack or the second sample rack, based on a detection result obtained by the first rack detection sensor and a detection result obtained by the second rack detection sensor.

14. The transporting apparatus of claim 1, wherein
the first sample rack is capable of holding a first number of the sample containers, and
the second sample rack is capable of holding a second number of the sample containers, the second number being greater than the first number.

15. A sample analyzer, comprising:
a transporting apparatus for transporting a sample rack capable of holding a plurality of sample containers;
a dispenser for dispensing a sample from each of the plurality of sample containers held by the sample rack transported by the transporting apparatus;
a measurement unit for performing measurement on the sample dispensed by the dispenser; and
an analysis unit for analyzing a measurement result obtained by the measurement unit, wherein
the transporting apparatus comprises:
a transporting path that has a width allowing placing of each of a first sample rack and a second sample rack having a length in longitudinal direction greater than that of the first sample rack, the transporting path extending in a transporting direction intersecting the longitudinal direction of the first sample rack or the second sample rack that has been placed on the transporting path; and
a transport mechanism configured for transporting each of the first sample rack and the second sample rack placed on the transporting path in the transporting direction.

16. The sample analyzer of claim 15, wherein
the transporting apparatus further comprises:
a second transporting path connected to a transport end portion of the transporting path and extending in a second transporting direction intersecting the transporting direction; and
a second transport mechanism for transporting each of the first sample rack and the second sample rack supplied on the second transporting path in the second transporting direction.

17. The sample analyzer of claim 15, further comprising:
a receiver for receiving an input of identification information for identifying a type of the first sample rack or the second sample rack to be transported by the transporting apparatus; and
a transport controller for controlling the second transport mechanism in accordance with the type of the first sample rack or the second sample rack, based on the identification information received by the receiver.

18. The sample analyzer of claim 15, further comprising:
a discriminator for discriminating a type of the first sample rack or the second sample rack to be transported by the transporting apparatus; and
a transport controller for controlling the transporting apparatus, in accordance with the type of the first sample rack or the second sample rack discriminated by the discriminator.

19. The sample analyzer of claim 18, wherein
the transporting apparatus comprises:
a first rack detection sensor provided at a position that allows detection of each of the first sample rack and the second sample rack placed on the transporting path; and
a second rack detection sensor provided at a position that allows detection of only the second sample rack placed on the transporting path, and
the discriminator discriminates the type of the first sample rack or the second sample rack, based on a detection result obtained by the first rack detection sensor and a detection result obtained by the second rack detection sensor.

20. The sample analyzer of claim 18, further comprising:
a receiver for receiving an input of identification information for identifying a type of the first sample rack or the second sample rack to be transported by the transporting apparatus; and
an alarming part for outputting an alarm when the type of the first sample rack or the second sample rack identified by the identification information received by the receiver is different from the type of the first sample rack or the second sample rack discriminated by the discriminator.
